(19) United States
(12) Patent Application Publication
(10) Pub. No.: US 2015/0186892 A1
(43) Pub. Date: Jul. 2, 2015

(54) METHODS AND SYSTEMS FOR VERIFYING A TRANSACTION

(71) Applicant: Tencent Technology (Shenzhen) Company Limited, Shenzhen (CN)

(72) Inventors: Wenpeng ZHANG, Shenzhen (CN); Chen GONG, Shenzhen (CN); Wenjing ZHANG, Shenzhen (CN); Yiyong YANG, Shenzhen (CN); Jiawei JIANG, Shenzhen (CN); Guoguo LlU, Shenzhen (CN); Yaqin GUO, Shenzhen (CN)

(21) Appl. No.: 14/588,823

(22) Filed: Jan. 2, 2015

Related U.S. Application Data
(63) Continuation of application No. PCT/CN2014/083533, filed on Aug. 1, 2014.

(30) Foreign Application Priority Data
Dec. 30, 2013 (CN) 201310744336.4

(51) Int. Cl. G06Q 20/40; G10L 17/24

(52) U.S. Cl. CPC G06Q 20/40145; G10L 17/24

(57) ABSTRACT

A server with processor(s) and memory receives a transaction request from a first device to perform a transaction with an account and determines a security level for the transaction. When the security level satisfies predetermined criterion, the server: instructs the first device to suspend the transaction and to display a first interface indicating the suspended transaction; and sends a confirmation request, to a second device associated with the account, for voice verification of the transaction. The server receives voice verification information from the second device that includes audio data provided by a user of the second device and determines whether the voice verification information matches stored account verification data corresponding to the account. When there is a match, the server: processes the transaction; and instructs the first device to complete the transaction and to replace display of the first interface with a second interface indicating the completed transaction.

### PRIORITY CLAIM AND RELATED APPLICATIONS

This application is a continuation application of PCT Patent Application No. PCT/CN2014/083533, entitled “METHODS AND SYSTEMS FOR VERIFYING A TRANSACTION” filed on Aug. 1, 2014, which claims priority to Chinese Patent Application Serial No. 201310744336.4, entitled “METHOD, BUSINESS SERVER, AND SYSTEM FOR SECURITY VERIFICATION,” filed on Dec. 30, 2013, the entirety of which is incorporated herein by reference.

### FIELD OF THE TECHNOLOGY

The present disclosure relates to the field of Internet technologies, and, more particularly, to a method and systems for real-time verification of a transaction.

### BACKGROUND OF THE TECHNOLOGY

At present, when a user sends a service request to a server, if the server detects a security risk in the service request, the server automatically interrupts (or suspends) the service request so as to ensure the security of user funds and information and/or to avoid security intrusions.

The service request may include a login request, a transaction request, a payment request, a session request, and the like. The service request is interrupted when, for example, a requested transaction exceeds an allowable transaction limit that was preset by the user, or that the previous login of the user to the service server has a security risk. Sometimes, a brief notification is displayed to inform the user of the reason for interrupting the service request. To that end, the user is prompted to initiate the service request again after the security risk is removed. However, it is usually time and energy consuming for a user to remove the security risk, and the service request needs to be initiated again.

### SUMMARY

In order to address the problems stated in the background section, the embodiments of the present disclosure provide methods and systems for real-time verification of a transaction.

In some embodiments, a method of real-time biometric verification of a transaction is performed at a server system (e.g., server system 108, FIGS. 1-2) with one or more processors and memory. The method includes receiving a transaction request from a first device to perform a transaction with an account. The method includes determining a security level for the transaction based on one or more parameters of the transaction and/or the account, in response to receiving the transaction request. In accordance with a determination that the security level for the transaction meets a predetermined criterion, the method includes: instructing the first device to suspend the transaction and to display a first interface on the first device indicating suspension of the transaction; and sending a confirmation request to a second device associated with the account to request voice verification for the transaction. The method includes receiving voice verification information from the second device in response to the confirmation request, where the voice verification information includes audio data provided by a user of the second device. The method includes determining whether the voice verification information matches stored account verification data corresponding to the account. In accordance with at least a determination that the voice verification information matches the stored account verification data corresponding to the account, the method includes: processing the transaction; and instructing the first device to complete the transaction and to replace display of the first interface on the first device with a second interface indicating completion of the transaction.

In some embodiments, a computer system (e.g., server system 108, FIGS. 1-2) includes one or more processors and memory storing one or more programs for execution by the one or more processors, the one or more programs include instructions for performing, or controlling performance of, the operations of any of the methods described herein. In some embodiments, a non-transitory computer readable storage medium storing one or more programs, the one or more programs comprising instructions, which, when executed by a computer system (e.g., server system 108, FIGS. 1-2) with one or more processors, cause the computer system to perform, or control performance of, the operations of any of the methods described herein. In some embodiments, a computer system (e.g., server system 108, FIGS. 1-2) includes means for performing, or controlling performance of, the operations of any of the methods described herein.

Various advantages of the present application are apparent in light of the descriptions below.

### BRIEF DESCRIPTION OF THE DRAWINGS

The aforementioned features and advantages of the application as well as additional features and advantages thereof will be more clearly understood hereinafter as a result of a detailed description of preferred embodiments when taken in conjunction with the drawings.

To describe the technical solutions in the embodiments of the present application or in the prior art more clearly, the following briefly introduces the accompanying drawings required for describing the embodiments or the prior art. Apparently, the accompanying drawings in the following description show merely some embodiments of the present application, and persons of ordinary skill in the art may still derive other drawings from these accompanying drawings without creative efforts.

FIG. 1 is a block diagram of a server-client environment in accordance with some embodiments.

FIG. 2 is a block diagram of a server system in accordance with some embodiments.

FIG. 3 is a block diagram of a point-of-sale (“POS”) device in accordance with some embodiments.

FIG. 4 is a block diagram of a client device in accordance with some embodiments.

FIGS. 5A-5C illustrate exemplary user interfaces at the POS device for verifying a transaction in real-time in accordance with some embodiments.

FIGS. 6A-6B illustrate exemplary user interfaces at the client device for verifying a transaction in real-time in accordance with some embodiments.

FIG. 7 illustrates a flow diagram of a method of verifying a transaction in real-time in accordance with some embodiments.

FIG. 8 illustrates a flow diagram of a method of verifying a transaction in real-time in accordance with some embodiments.

FIG. 9 illustrates a flowchart diagram of a method of verifying a transaction in real-time in accordance with some embodiments.

FIGS. 10A-10C illustrate a flowchart diagram of a method of verifying a transaction in real-time in accordance with some embodiments.

FIG. 11A illustrates a block diagram of a service server in accordance with some embodiments.

FIGS. 11B-11C illustrate block diagrams of modules associated with the service server in FIG. 11A in accordance with some embodiments.

FIG. 12 illustrates a block diagram of a payment server in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without creative efforts shall fall within the protection scope of the present application.

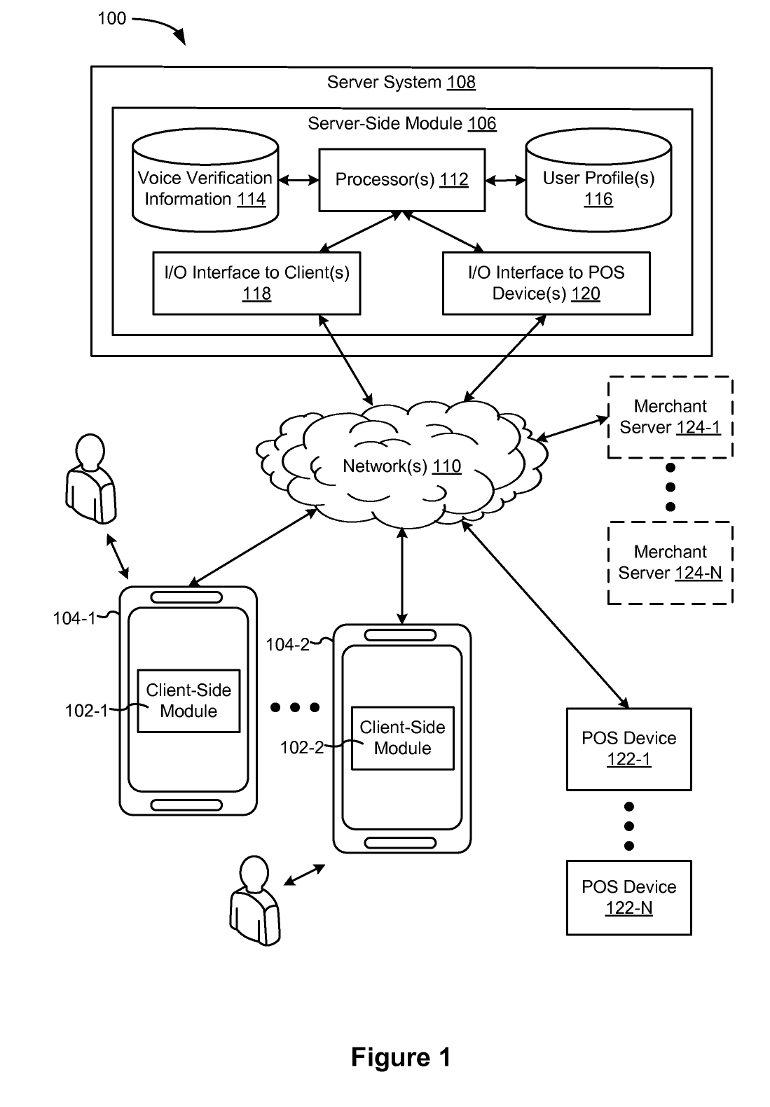

As shown in FIG. 1, data processing for verifying a transaction is implemented in a server-client environment 100 in accordance with some embodiments. Data processing includes point-of-sale (“POS”) device 122 where the transaction is initiated, server-side processing 106 (hereinafter “server-side module 106”) executed on a server system 108, and client-side processing 102-1, 102-2 (hereinafter “client-side module 102”) executed on a client device 104-1, 104-2. Server-side module 104 communicates with client-side module 102 and POS devices 122 through one or more networks 110. Server-side module 106 provides server-side functionalities associated with the verification process for any number of POS devices 122. Client-side module 102 provides client-side functionalities associated with the verification process such as user-facing input and output processing (e.g., capturing voice verification information from the user) and communications with server-side module 106.

In some embodiments, POS devices 122 additionally communicate with merchant servers 124 via one or more networks 110. For example, after a transaction is completed, a respective POS device 122 sends transaction details corresponding to the completed transaction (e.g., a transaction amount, transaction time, transaction location, and the goods and/or services included transaction) to a respective merchant server 124 that is associated with the respective POS device 122 for accounting, inventory, and data collection purposes.

In some embodiments, server-side module 106 includes one or more processors 112, voice verification information 114, one or more user profiles 116, an I/O interface to one or more clients 118, and an I/O interface to one or more POS devices 120. I/O interface to one or more clients 118 facilitates the client-facing input and output processing for server-side module 106, and I/O interface to one or more POS devices 120 facilitates the POS-facing input and output processing for server-side module 106. One or more processors 112 receive a transaction request from a POS device 122, send a confirmation request to a client device 104 for voice verification information to confirm the transaction, and determine whether received voice verification information matches stored account verification data. Voice verification information 114 stores previously received voice verification information, and one or more user profiles 116 store one or more user profiles each associated with a respective user of a client device including information associated with the respective user's account such as account verification data (e.g., social security number, date of birth, security question and answer, biometric voice signature, and the like), account preferences, authorization level, transaction history, verification history, and identified trends and/or likes/dislikes. In some embodiments, server-side module 106 communicates with one or more POS devices 122 (e.g., merchant/retail POS devices, a first device associated with the user, etc.) through one or more networks 110. I/O interface to one or more POS devices 120 facilitates such communications.

Examples of a representative client device 104 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of a representative POS device 122 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

Server-client environment 100 shown in FIG. 1 includes both a client-side portion (e.g., client-side module 102) and a server-side portion (e.g., server-side module 106). In some embodiments, data processing is implemented as a standalone application installed on client device 104. In addition, the division of functionalities between the client and server portions of client environment data processing can vary in different embodiments. For example, in some embodiments, client-side module 102 is a thin-client that provides only user-facing input and output processing functions, and delegates all other data processing functionalities to a backend server (e.g., server system 108).

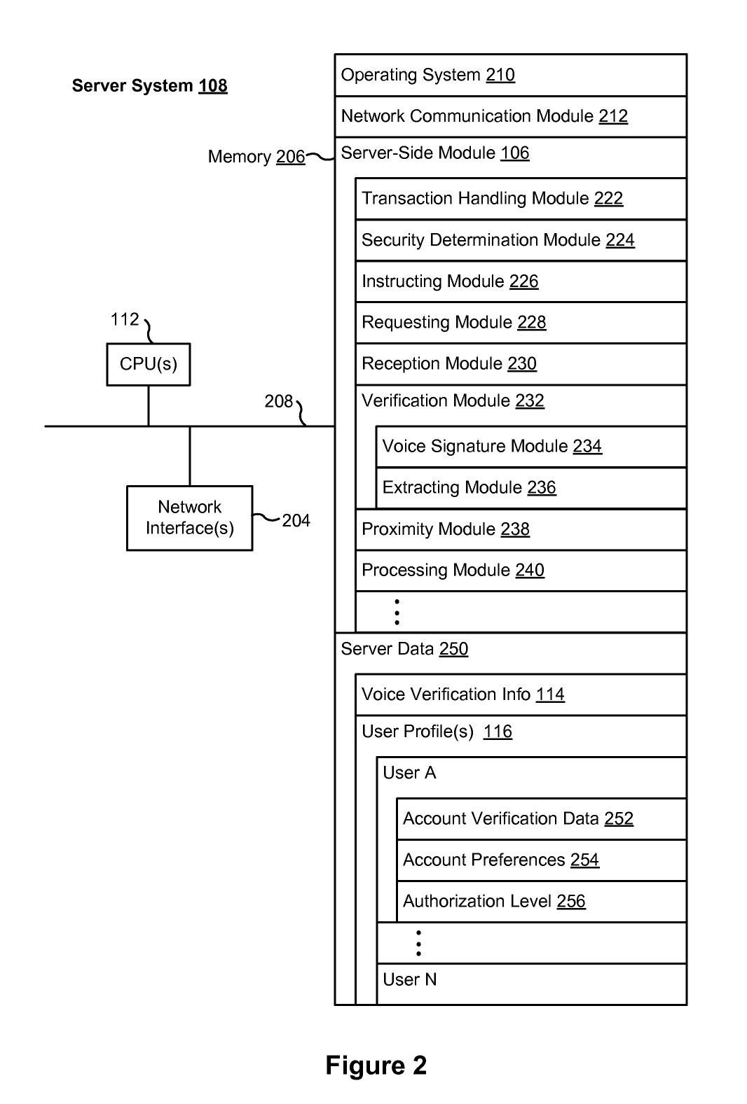

FIG. 2 is a block diagram illustrating server system 108 in accordance with some embodiments. Server system 108, typically, includes one or more processing units (CPUs) 112, one or more network interfaces 204 (e.g., including I/O interface to one or more clients 118 and I/O interface to one or more POS devices 120), memory 206, and one or more communication buses 208 for interconnecting these components (sometimes called a chipset). Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 112. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
operating system 210 including procedures for handling various basic system services and for performing hardware dependent tasks;
network communication module 212 that is used for connecting server system 108 to other computing devices (e.g., client devices 104 and POS devices 122) connected to one or more networks 110 via one or more network interfaces 204 (wired or wireless);
server-side module 106, which provides server-side data processing and functionalities, includes, but is not limited to:
   transaction handling module 222 for receiving a transaction request from a first device (e.g., POS device 122) to perform a transaction that corresponds to an account;
   security determination module 224, responsive to the transaction request, for determining a security level corresponding to the transaction based on one or more parameters of the transaction and/or the account;
   instructing module 226 for instructing the first device to suspend the transaction and to display a first interface on the first device indicating suspension of the transaction and, also, for instructing the first device to complete the transaction and to replace display of the first interface on the first device with a second interface indicating completion of the transaction;
   requesting module 228 for sending a confirmation request to a second device (e.g., client device 104) associated with the account to request voice verification for the transaction;
   reception module 230, responsive to the confirmation request, for receiving voice verification information, from the second device, that includes audio data provided by a user of the second device;
   verification module 232 for determining whether the voice verification information matches account verification data stored in a respective user profile 116 of a respective user who corresponds to the account, including but not limited to:
      voice signature module 234 for extracting a voice signature from the voice verification information; and
      extracting module 236 for extracting a portion of the voice verification information in accordance with predetermined privacy criterion stored in a respective user profile 116 of a respective user who corresponds to the account;
   proximity module 238 for determining whether the first device and the second device are located within a predetermined distance based on the locations received from the first and second devices; and
   processing module 240 for processing the transaction in accordance with a determination that the voice verification information matches the stored account verification data; and
server data 250, including but not limited to:
   voice verification information 114 storing previously received voice verification information; and
   one or more user profiles 116 storing one or more user profiles each associated with a respective user, including information associated with the respective user's account such as:
      account verification data 252 (e.g., social security number, date of birth, security question and answer, biometric voice signature, and the like);
      account preferences 254 (e.g., predetermined privacy criterion, a transaction amount cap, daily total transaction(s) amount cap, and so on);
      authorization level 256 (e.g., limited authority sub-user, non-limited authority sub-user, administrator, etc.); and
      other information associated with the respective user such as transaction history, verification history, and identified trends and/or likes/dislikes of the respective user.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

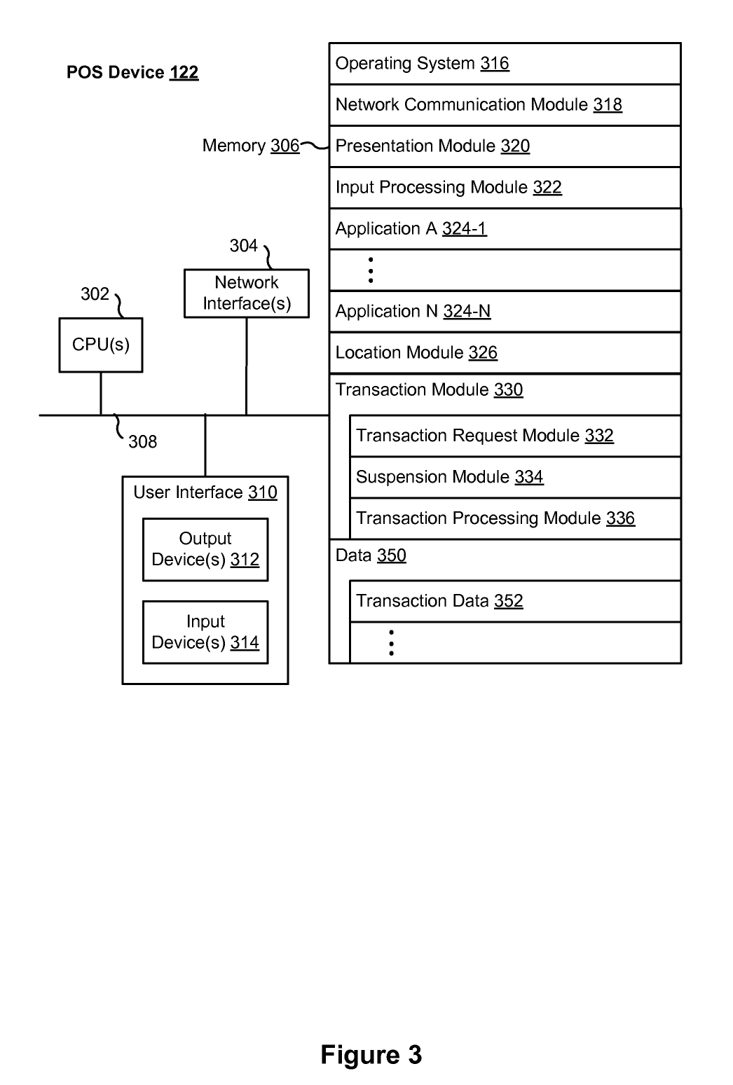

FIG. 3 is a block diagram illustrating a representative POS device 122 in accordance with some embodiments. POS device 122, typically, includes one or more processing units (CPUs) 302, one or more network interfaces 304, memory 306, and one or more communication buses 308 for interconnecting these components (sometimes called a chipset). POS device 122 also includes a user interface 310. User interface 310 includes one or more output devices 312 that enable presentation of media content, including one or more speakers and/or one or more visual displays. User interface 310 also includes one or more input devices 314, including user interface components that facilitate user input such as a keyboard, a mouse, a voice-command input unit or microphone, a touch screen display, a touch-sensitive input pad, a gesture capturing camera, or other input buttons or controls. Furthermore, some POS devices 122 use a microphone and voice recognition or a camera and gesture recognition to supplement or replace the keyboard. Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting POS device 122 to other computing devices (e.g., server system 108 and one or more merchant servers 124) connected to one or more networks 110 via one or more network interfaces 304 (wired or wireless);
presentation module 320 for enabling presentation of information (e.g., a user interface for a widget, webpage, game, or an application, audio and/or video content, text, etc.) at client device 104 via one or more output devices 312 (e.g., displays, speakers, etc.) associated with user interface 310; and
input processing module 322 for detecting one or more user inputs or interactions from one of the one or more input devices 314 and interpreting the detected input or interaction;
one or more applications 324-1-324-N for execution by POS device 122 (e.g., a web browser, payment/transaction application, etc.); and
location module for determining the location of POS device 122 and providing the location of POS device 122 to server system 108.

In some embodiments, memory 306 also includes transaction module 330, which initiates a transaction. Transaction module 330 includes, but is not limited to:
transaction request module 332 for sending a transaction request to server system 108 in response to a user input initiating a transaction session for the transaction;
suspension module 334 for suspending the transaction in response to instructions from server system 108; and
transaction processing module 336 for completing the transaction and, optionally, sending transaction details to one or more merchant servers 124.

In some embodiments, memory 306 also includes data 350 including, but not limited to transaction data 352 associated with the transaction and previously processed transactions.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

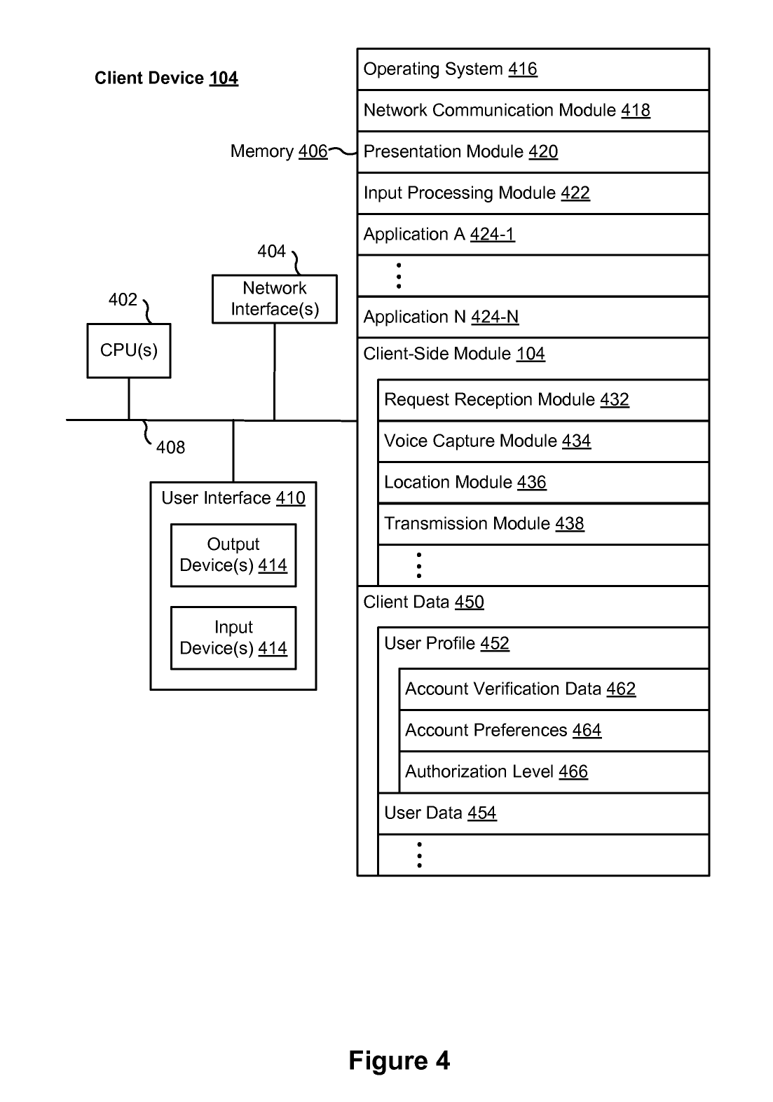

FIG. 4 is a block diagram illustrating a representative client device 104 associated with a user in accordance with some embodiments. Client device 104, typically, includes one or more processing units (CPUs) 402, one or more network interfaces 404, memory 406, and one or more communication buses 408 for interconnecting these components (sometimes called a chipset). Client device 104 also includes a user interface 410. User interface 410 includes one or more output devices 412 that enable presentation of media content, including one or more speakers and/or one or more visual displays. User interface 410 also includes one or more input devices 414, including user interface components that facilitate user input such as a keyboard, a mouse, a voice-command input unit or microphone, a touch screen display, a touch-sensitive input pad, a gesture capturing camera, or other input buttons or controls. Furthermore, some client devices 104 use a microphone and voice recognition or a camera and gesture recognition to supplement or replace the keyboard. Memory 406 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 406, optionally, includes one or more storage devices remotely located from one or more processing units 402. Memory 406, or alternatively the non-volatile memory within memory 406, includes a non-transitory computer readable storage medium. In some implementations, memory 406, or the non-transitory computer readable storage medium of memory 406, stores the following programs, modules, and data structures, or a subset or superset thereof:
operating system 416 including procedures for handling various basic system services and for performing hardware dependent tasks;
network communication module 418 for connecting client device 104 to other computing devices (e.g., server system 108) connected to one or more networks 110 via one or more network interfaces 404 (wired or wireless);
presentation module 420 for enabling presentation of information (e.g., a user interface for a widget, webpage, game, or an application, audio and/or video content, text, etc.) at client device 104 via one or more output devices 412 (e.g., displays, speakers, etc.) associated with user interface 410; and
input processing module 422 for detecting one or more user inputs or interactions from one of the one or more input devices 414 and interpreting the detected input or interaction; and
one or more applications 424-1-424-N for execution by client device 104 (e.g., a web browser, a payment/transaction application for security verification, etc.).

In some embodiments, memory 406 also includes client-side module 102, which provides client-side data processing and functionalities. Client-side module 102 includes, but is not limited to:
request reception module 432 for receiving a confirmation request for voice verification of a transaction initiated at a POS device 122;
voice capture module 434, responsive to the confirmation request, for capturing voice verification information via one or more input devices 414 (e.g., a microphone);
location module 436 for determining the location of client device 104 and providing the location of client device 104 to server system 108; and
transmission module 438 for transmitting the voice verification information to server system 108.

In some embodiments, memory 406 also includes client data 450 including, but is not limited to:
user profile 452 for a respective user of client device 104 including information associated with the respective user's account such as:
   account verification data 252 (e.g., social security number, date of birth, security question and answer, biometric voice signature, and the like);
   account preferences 254 (e.g., predetermined privacy criterion, a transaction amount cap, daily total transaction(s) amount cap, and so on);
   authorization level 256 (e.g., limited authority sub-user, non-limited authority sub-user, administrator, etc.); and
   other information associated with the respective user such as transaction history, verification history, and identified trends and/or likes/dislikes of the respective user; and
user data 454 including information associated with the account.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 406, optionally, stores a subset of the modules and data structures identified above. Furthermore, memory 406, optionally, stores additional modules and data structures not described above.

In some embodiments, at least some of the functions of client-side module 102 are performed by POS device 122, and the corresponding sub-modules of these functions may be located within POS device 122 rather than client-side module 102. In some embodiments, at least some of the functions of POS device 122 are performed by client-side module 102, and the corresponding sub-modules of these functions may be located within client-side module 102 rather than POS device 122. POS device 122 and client device 104 shown in FIGS. 3-4, respectively, are merely illustrative, and different configurations of the modules for implementing the functions described herein are possible in various embodiments.

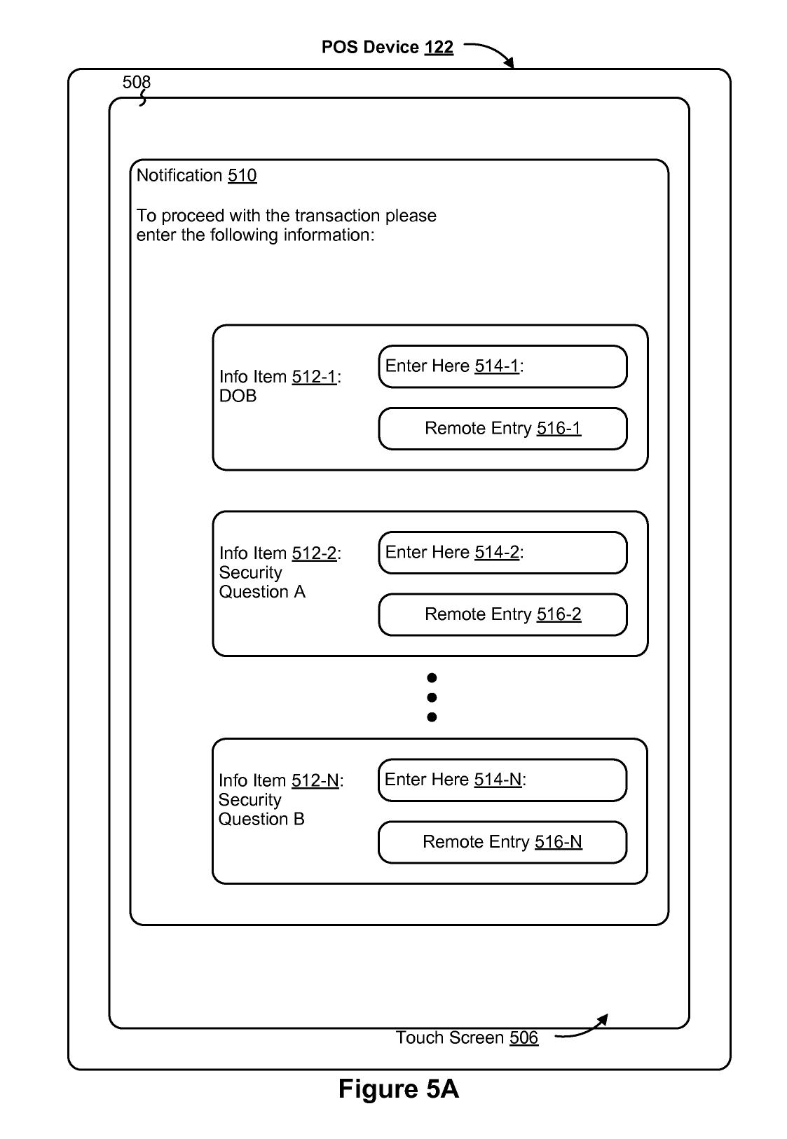

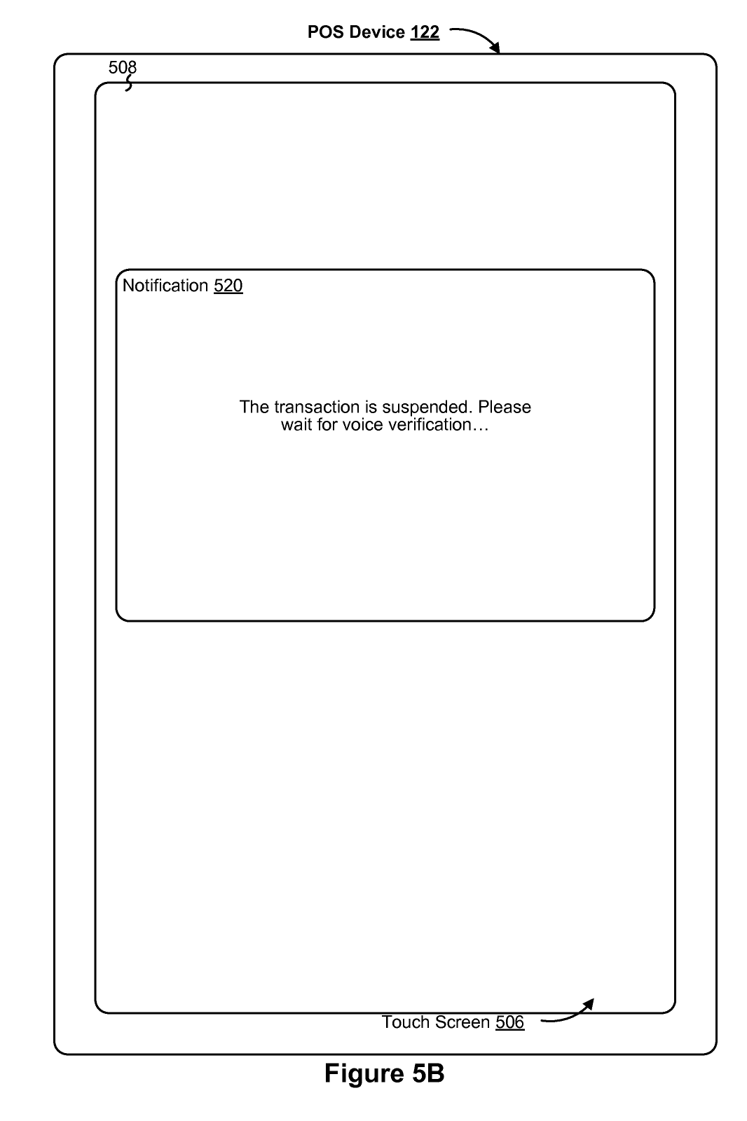

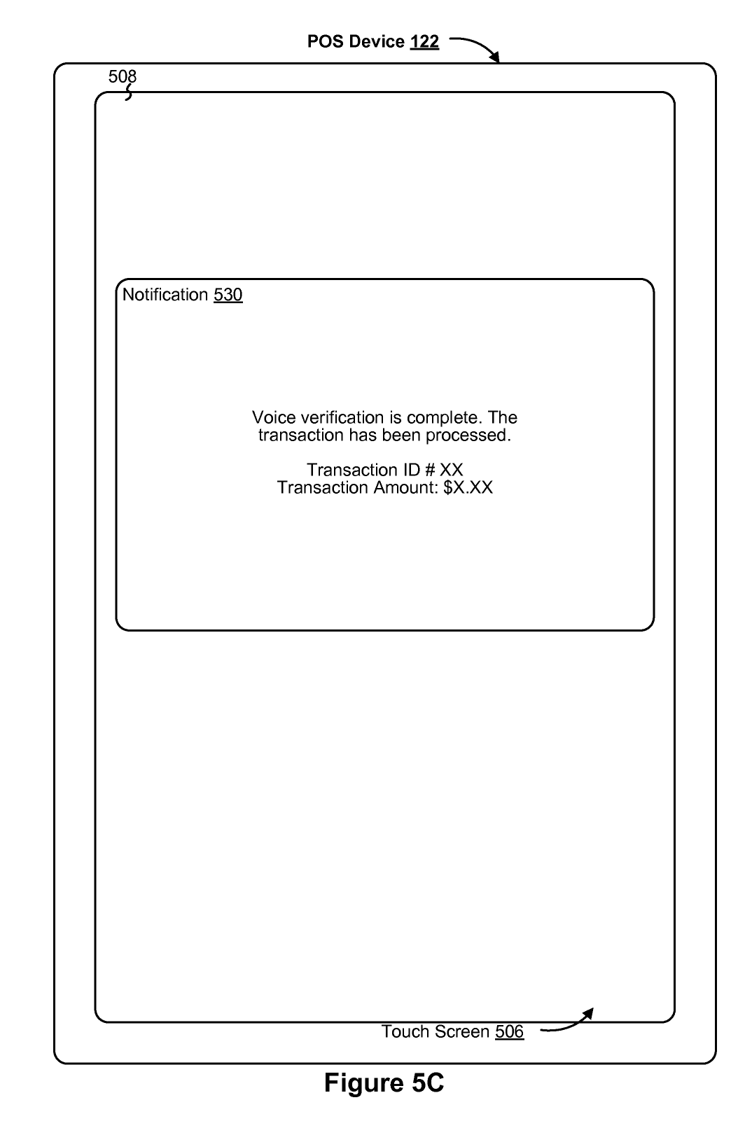

Attention is now directed towards embodiments of user interfaces and associated processes that may be implemented on a respective POS device 122 with a touch screen 506 (sometimes also herein called a touch screen display) enabled to receive one or more contacts and display information (e.g., media content, webpages and/or user interfaces for a payment/transaction application). FIGS. 5A-5C illustrate exemplary user interfaces for verifying a transaction in accordance with some embodiments.

Although some of the examples that follow will be given with reference to inputs on touch screen 506 (where the touch sensitive surface and the display are combined), in some embodiments, the device detects inputs on a touch-sensitive surface that is separate from the display. In some embodiments, the touch sensitive surface has a primary axis that corresponds to a primary axis on the display. In accordance with these embodiments, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based, stylus-based, or physical button-based input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact) or depression of a physical button. Similarly, when multiple user inputs are simultaneously detected, it should be understood that multiple computer mice are, optionally, used simultaneously, or a mouse and finger contacts are, optionally, used simultaneously.

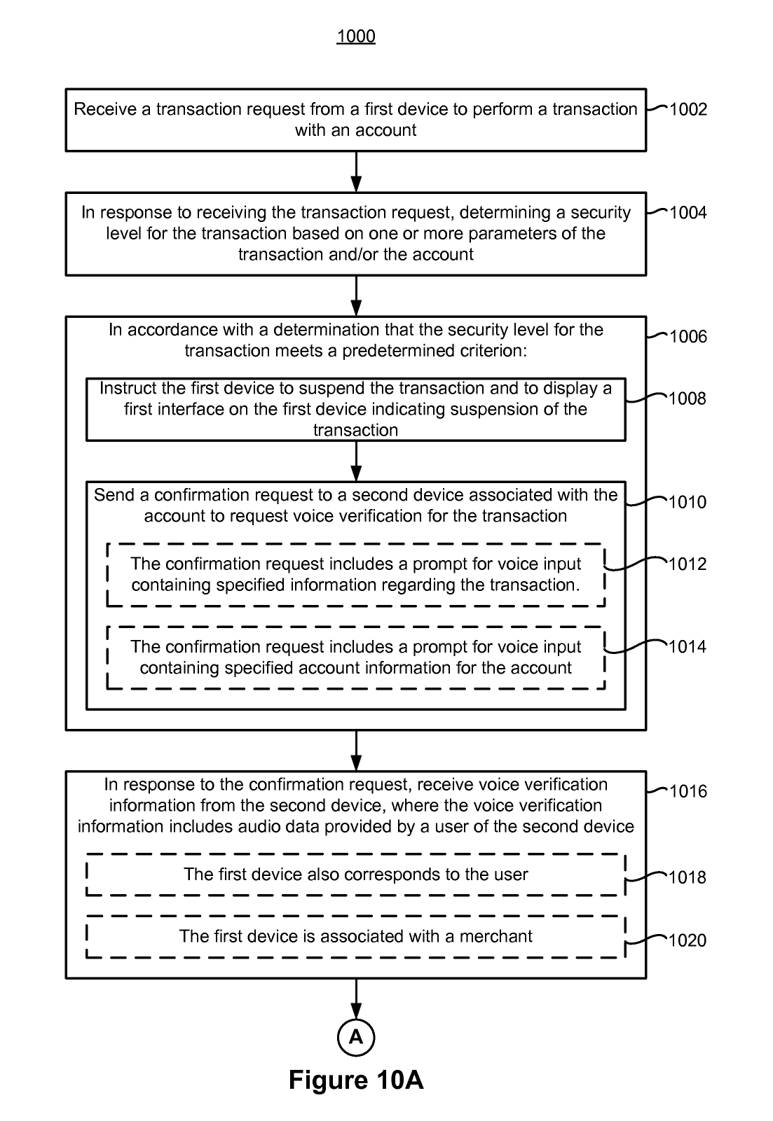

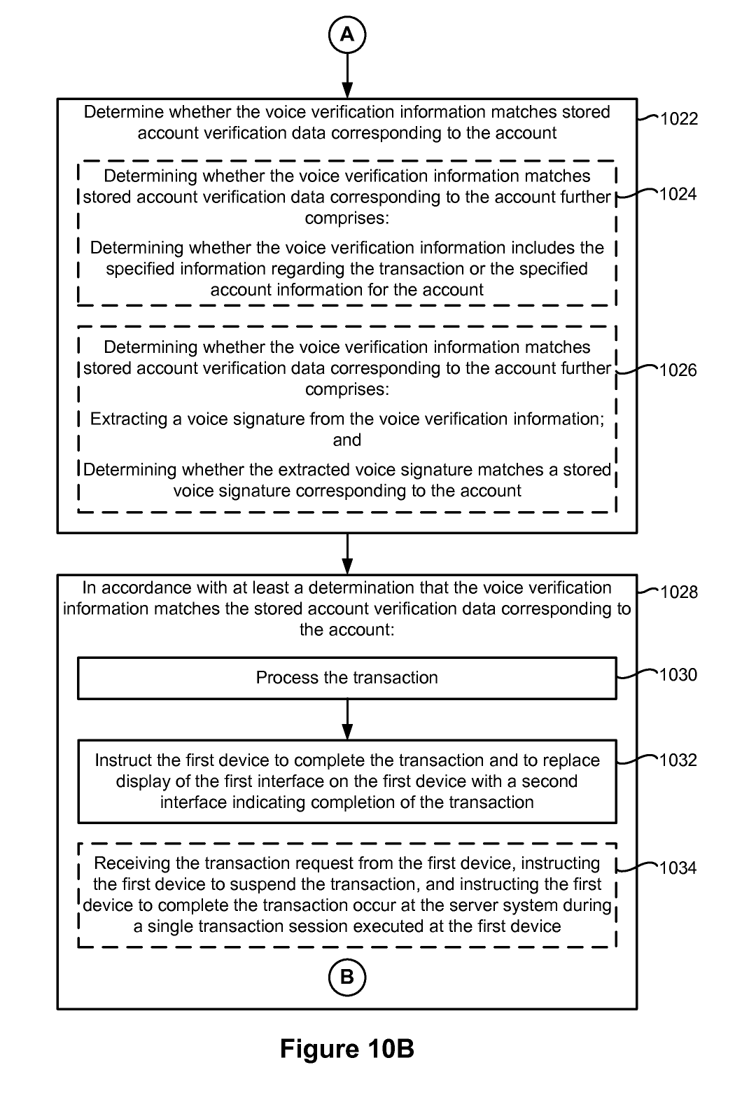

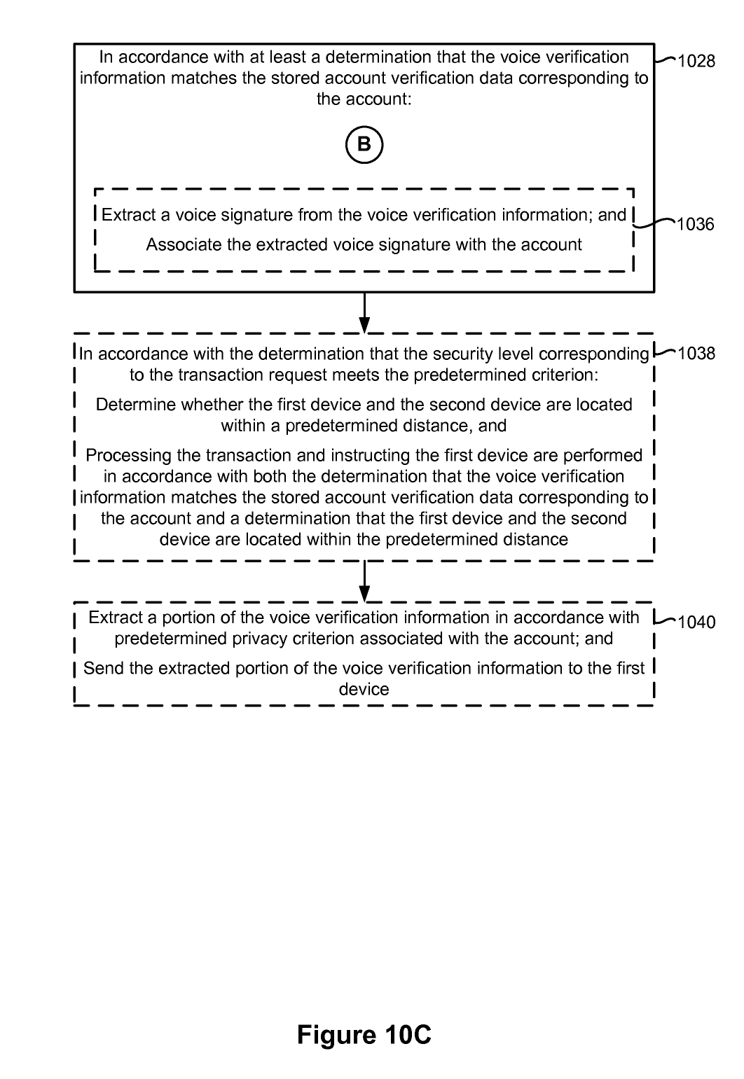

FIGS. 5A-5C show interface 508 for a payment/transaction application displayed on POS device 122 (e.g., a mobile or desktop/fixed payment terminal); however, one skilled in the art will appreciate that the user interfaces shown in FIGS. 5A-5C may be implemented on other similar computing devices. The user interfaces in FIGS. 5A-5C are used to illustrate the processes described herein, including the process described with respect to FIGS. 10A-10C.

FIG. 5A illustrates POS device 122 displaying an interface for a payment/transaction application on touch screen 506. For example, in FIGS. 5A-5C, POS device 122 is a payment terminal installed in a merchant establishment that enables a purchaser of the merchant to pay for goods and services via the payment/transaction application. In another example, in FIGS. 5A-5C, POS device 122 is a user device with limited capabilities, and the user (i.e., the purchaser) initiates a transaction via the payment/transaction application executed on the user device. According to either of the aforementioned examples, POS device 122 includes a magnetic card reader (e.g., a credit card reader) and touch screen 506 for entering information associated with a transaction and completing the transaction.

In FIG. 5A, the interface for the payment/transaction application includes notification 510 prompting the user of POS device 122 (e.g., the purchaser of goods or services) to enter information in order to proceed with a transaction. In FIG. 5A, the user is required to fill out information items 512-1, 512-2, . . . , 512-N (e.g., date of birth, security question A, and security question B) in order to proceed with the transaction. For information item 512-1, the user of POS device 122 is able to fill out the information requested for information item 512-1 in text entry box 514-1 via a physical keyboard, virtual keyboard, or voice input. Alternatively, the user of POS device 122 is able to fill out the information requested for information item 512-1 by selecting remote entry affordance 516-1, which, when activated (e.g., by a touch input from the user), causes POS device 122 to send a notification to server system 108 that the user associated with the transaction wishes to fill out the information requested for information item 512-1 at a second device associated with the user who initiated the transaction. For example, in response to receiving the notification, server system 108 sends a confirmation request to the second device associated with the user to fill out the information requested for information item 512-1.

For example, in response to selection of remote entry affordance 516-1, biometric information (e.g., voice input) associated with information items 512-1 is input via the user's mobile device (i.e., the second device) and checked by server system 108. In this example, when the biometric information checks out, POS device 122 receives a verification notification from server system 108 indicating completion of the transaction of but POS device 122 never receives the actual biometric information. As such, this indirection input of biometric information maintains the user's security and limits the dissemination of the user's sensitive information. In some embodiments, voice input is preferred over other types of biometric information because additional content-based security verification information (e.g., account information, transaction data, personal data, etc.) can be included in the voice input and used to further improve security. In some embodiments, the remote entry of other types of information (e.g., passwords, fingerprints, personal data, etc.) using other input methods is also possible.

FIG. 5B illustrates POS device 122 displaying notification 520 on touch screen 506. In FIG. 5B, notification 520 indicates that the transaction has been suspended pending voice verification from a second device associated with the account that was used to initiate the transaction. For example, server system 108 has sent a confirmation request to the second device for voice verification of the transaction.

FIG. 5C illustrates POS device 122 displaying notification 530 on touch screen 506. In FIG. 5C, notification 530 indicates that the voice verification information has been received and confirmed and that the transaction has been completed. In FIG. 5C, notification 530 also includes an identifier number and the amount of the completed transaction.

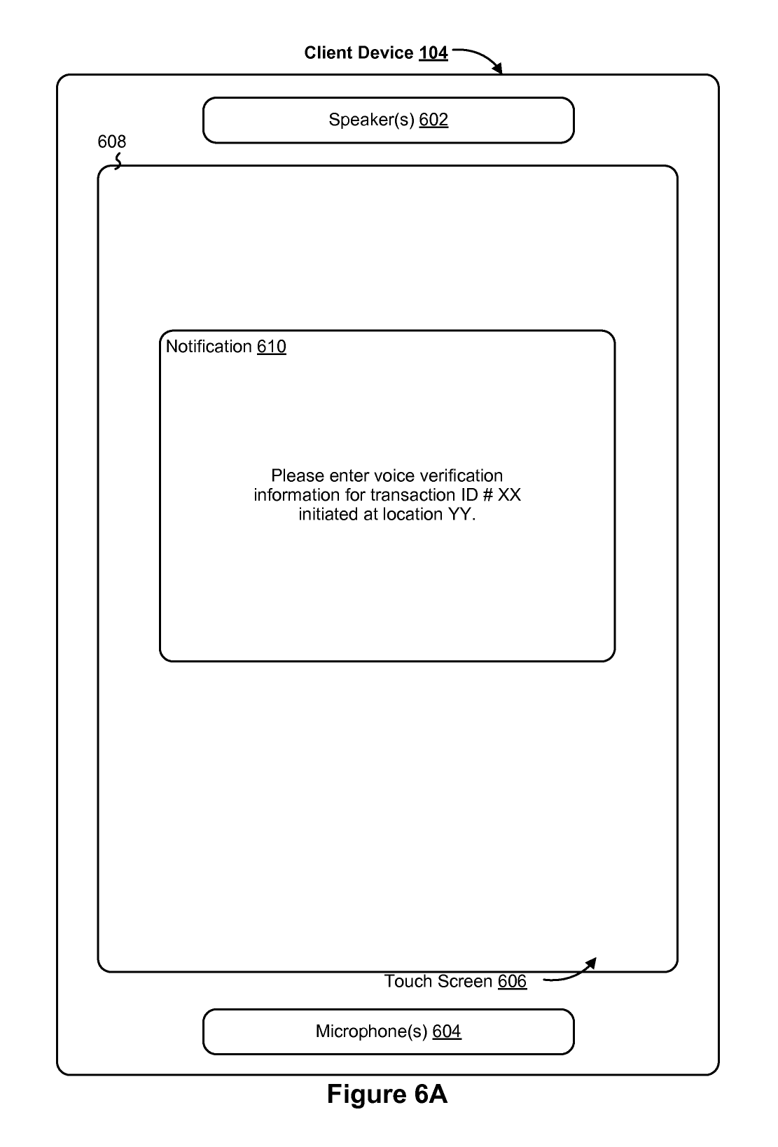

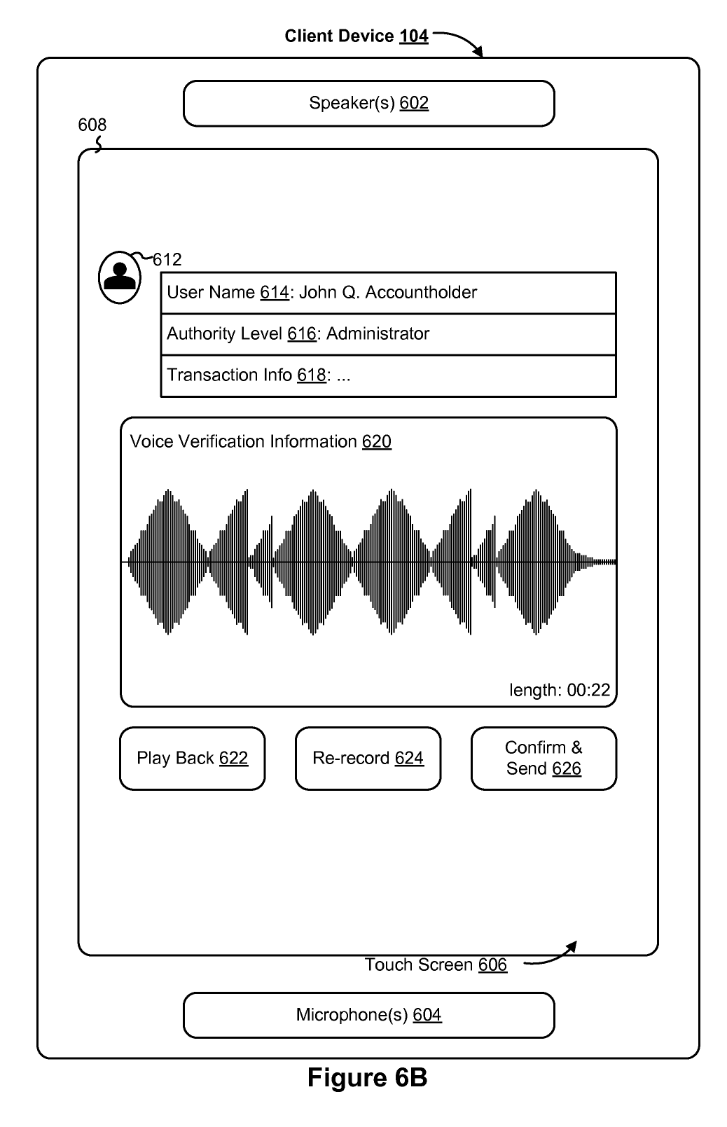

Attention is now directed towards embodiments of user interfaces and associated processes that may be implemented on a respective client device 104 with one or more speakers 602 enabled to output sound, zero or more microphones 604 enabled to receive sound input, and a touch screen 606 (sometimes also herein called a touch screen display) enabled to receive one or more contacts and display information (e.g., media content, webpages and/or user interfaces for an application). FIGS. 6A-6B illustrate exemplary user interfaces for verifying a transaction in accordance with some embodiments.

Although some of the examples that follow will be given with reference to inputs on touch screen 606 (where the touch sensitive surface and the display are combined), in some embodiments, the device detects inputs on a touch-sensitive surface that is separate from the display. In some embodiments, the touch sensitive surface has a primary axis that corresponds to a primary axis on the display. In accordance with these embodiments, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIGS. 6A-6B show interface 608 for a payment/transaction application displayed on client device 104 (e.g., a mobile phone or tablet); however, one skilled in the art will appreciate that the user interfaces shown in FIGS. 6A-6B may be implemented on other similar computing devices. The user interfaces in FIGS. 6A-6B are used to illustrate the processes described herein, including the process described with respect to FIGS. 10A-10C.

FIG. 6A illustrates client device 104 displaying, on touch screen 606, an interface for the payment/transaction application prior to the entrance of voice verification information. In FIG. 6A, the interface for the payment/transaction application includes notification 610 prompting the user of client device 104 to enter voice verification information for a transaction. In FIG. 6A, notification 610 includes the identifier for the transaction and the location where the transaction was initiated (e.g., the location of a POS device 122). For example, client device 104 is a personal user device associated with the administrator of the account that was used to initiate the transaction at POS device 122.

FIG. 6B illustrates client device 104 displaying, on touch screen 606, an interface for the payment/transaction application after the entrance of voice verification information. In FIG. 6B, the interface includes information corresponding to the user of client device such as initials, an avatar, or an image 612, user name 614, and authority level 616. For example, the user of client device 104 (e.g., John Q. Accountholder) is the administrator of the account used to initiate the transaction at POS device 122. Continuing with this example, John Q. Accountholder's account was used to initiate a transaction at a POS device 122 by his child; however, John Q. Accountholder's account preferences require his voice verification prior to competition of any transaction initiated by a sub-user of the account (i.e., non-administrator) with a restricted authorization level or limited authority (e.g., John Q. Accountholder's child).

In FIG. 6B, the interface also includes information 618 corresponding to the transaction such as identifier number, location, time and date, amount, and so on. In FIG. 6B, the interface further includes voice verification information 620 recorded by the user of client device 104. For example, voice verification information 620 shows the waveform of the recorded voice input and the length of the recorded voice input. In some embodiments, play-back affordance 622, when activated (e.g., by a touch input from the user), causes client device 104 to play-back the voice verification information 620. In some embodiments, re-record affordance 624, when activated (e.g., by a touch input from the user), causes client device 104 to delete previously recorded voice verification information 620 and initiate recording of new voice verification information 620. In some embodiments, confirm and send affordance 626, when activated (e.g., by a touch input from the user), causes client device 104 to confirm voice verification information 620 and to send recorded voice verification information 620 to server system 108.

In an example usage scenario, when a user is standing in front of a POS device in a store, and after making a selection for remote entry of required verification information (e.g., as shown in FIG. 5A), the POS device displays the notification regarding suspension of the transaction (e.g., as shown in FIG. 5B). At substantially the same time, the user receives the notification on his registered device (e.g., a mobile phone associated with the account) (e.g., as shown in FIG. 6A). The user enters the required voice input using his registered device (e.g., as shown in FIG. 6B). Once the server receives and verifies the voice input received from the registered device of the user, the server sends a confirmation to the POS device, and the POS device displays the notification indicating that the voice verification has been completed, and the transaction has been processed (as shown in FIG. 5C). The entire transaction process is completed within the same session at the POS device in real-time, while the user is waiting in front of the POS device.

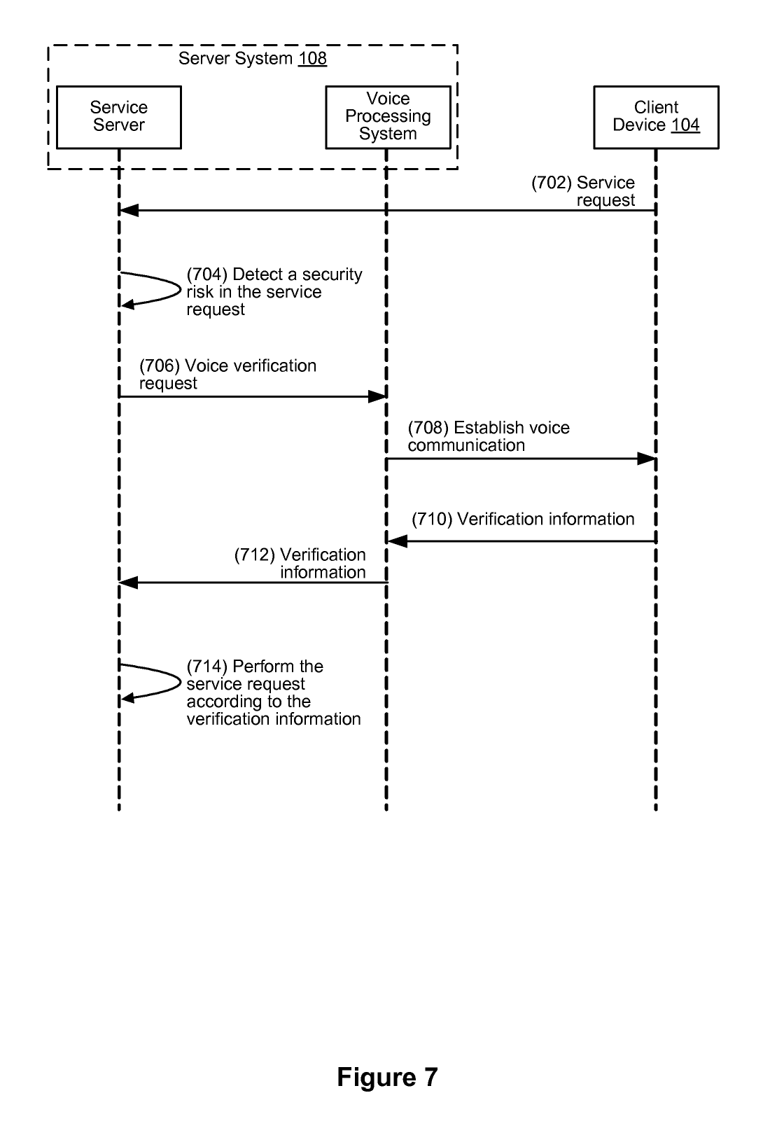

FIG. 7 illustrates a flow diagram of a security verification process in accordance with some embodiments. In some embodiments, the process is performed in server-client environment 100 (FIG. 1) with server system 108 (e.g., including a service server and a voice processing system) and client device 104.

In some embodiments, the service server obtains (702) a service request submitted by a user at client device 104. In some embodiments, the user uses a user terminal such as a mobile phone, a personal computer, and a tablet computer to submit the service request to the service server through a payment/transaction application, a service submission web page, an instant messaging client, a simple notification service (“SNS”) client, or the like. In some embodiments, the service request includes a login request, a transaction request, a payment request, a session request, and the like, where the transaction request and the payment request may include payment information such as a transaction order and a payment amount.

In some embodiments, the service server detects (704) a security risk in the service request. In some embodiments, in accordance with a preset risk assessment mechanism, the service server performs a risk assessment process on the service request. For example, the service server determines whether the payment amount of the service request exceeds a daily payment limit predetermined by the user, whether a previous login of the user to the service server had a security risk, whether the good or service corresponding to the service request has a security risk, or the like.

If the service server determines that the service request has a security risk, the service server performs step 706. Additionally and/or optionally, in some embodiments, the service server further assigns a security risk level to the service request according to the preset risk assessment mechanism. For example, the security risks are classified into high, medium, and low risk levels. If the service request is assigned a high risk level, the service server rejects the service request. If the service request is assigned a low risk level, the service server performs the service request and returns a message indicating that the service processing is successful. If the service request is assigned a medium risk level, the service server performs step 706.

In some embodiments, the service server sends (706) a voice verification request to the voice processing system. In some embodiments, the voice verification request includes voice contact information preset by the user. In some embodiments, the user submits to the service server voice contact information. In turn, the service server saves the voice contact information and associates it with a user identifier, such as a login name, of the user. For example, the voice contact information is a fixed-line phone number, a mobile phone number, a voice communication platform number, an instant messaging number, an SNS account, or the like.

After detecting a security risk in step 704, the service server sends the voice verification request to the voice processing system. The voice verification request instructs the voice processing system to establish voice communication with the user using the voice contact information included in the voice verification request. In an optional embodiment, the voice verification request further includes verification content information (e.g., transaction amount, date of birth, security question, and so on), which is used by the voice processing system to prompt the user to provide verification information that corresponds to the verification content information.

In some embodiments, the voice processing system establishes (708) voice communication with client device 104. In some embodiments, the voice processing system establishes voice communication with client device 104 according to the voice contact information included in the voice verification request. For example, the voice processing system dials a fixed-line phone number or mobile phone number preset by the user, and after the user answers the call, the voice communication is established. In some embodiments, the voice processing system prompts, manually or by means of automatic voice, the user to provide verification information via the established voice communication. For example, the voice processing system plays a preset voice prompt, such as “Please enter the order number of this payment, and press the pound key.” Additionally and/or optionally, in some embodiments, the voice processing system chooses one of a plurality of voice prompts to play based on the verification content information included in the voice verification request. As such, the user is prompted to enter different verification information. For example, the voice verification request includes one or more items of verification content information such as “order number,” “payment password,” “payment amount,” “registered contact number,” and the like. For example, if the service request is an online payment request, the voice processing system prompts the user to enter payment information such as an order number, a payment amount, or a payment password of this payment request. Further, in an optional embodiment, if the user submits the service request to the service server through a client that supports voice communication (e.g., an instant messaging client or an SNS client) the voice processing system directly sends the voice communication request to the client, so as to establish voice communication with the user through the client.

In some embodiments, the voice processing system obtains (710), by means of the voice communication, the verification information from the user of client device 104. In some embodiments, during voice communication with the voice processing system, the user uses a physical keypad or virtual keys on the user terminal to enter, according to the prompt of the voice processing system, corresponding information related to voice verification request. The verification information fed back by the user includes any one or any combination of: a transaction order number, a payment amount, a payment password, and a registered mobile phone number. For example, the voice processing system gives the following prompt to the user: “Please enter the order number of this payment, and press the pound key.” Continuing with this example, the user enters the order number of this transaction by pressing keys of the user terminal, and the voice processing system obtains, by means of the voice communication with the user, the order number entered by the user. Subsequently, the voice processing system gives the following prompt to the user: “Please enter the amount of this payment, and press the pound key.” Continuing with this example, the user enters the amount of the transaction by pressing keys of the user terminal, and the voice processing system obtains, by means of the voice communication with the user, the payment amount entered by the user. After obtaining all required verification information, which is default or determined according to the verification content information specified in the voice verification request, the voice processing system notifies the user that the voice verification is completed.

Alternatively, in some embodiments, the user provides the verification information to the voice processing system by means of voice. For example, according to the prompt, the user reads the information related to the service request during the voice communication. The voice processing system obtains the voice information which serves as the verification information, and returns the obtained voice information to the service server. Further optionally, the voice processing system prompts the user to read a sentence (e.g., the verification content information, or another piece of information such as “I am XX, and I confirm this payment.”). The voice processing system sends the whole piece of voice information to the service server as a service credential of this service request.

In some embodiments, the voice processing system sends (712) the obtained verification information to the service server.

In some embodiments, the service server performs (714) service processing on the service request according to the verification information from the user. In some embodiments, the service server verifies the obtained verification information by determining whether the verification information is the same as the related information corresponding to the service request (e.g., by comparison). For example, if the service request is a payment request, the service server determines whether the order number included in the verification information is the order number corresponding to the current service request, whether the payment amount included in the verification information is the payment amount corresponding to the current service request, whether the payment password included in the verification information is the payment password preset by the user, whether the password included in the verification information is the payment password preset by the user, or the like. If the verification succeeds, the service server performs subsequent service processing of the service request.

Alternatively and/or additionally, in some embodiments, the verification information includes voice information from the user. In this event, the service server performs voice recognition on the voice information to verify that the voice signature in the voice information matches a voice signature corresponding to the user of the account used to initiate the transaction.

Further, in some embodiments, the service server adjusts the security risk level assessment of the current service request according to the verification result. For example, if the verification succeeds, the security risk is downgraded by one level; in other words, it is determined that the current service request has a lower risk. If the verification fails, the security risk is upgraded by one level; in other words, it is determined that the current service request has a higher risk.

When detecting a security risk in a service request submitted by a user, the service server performs voice communication with the user via a voice processing system, so as to obtain verification information from the user. Moreover, the service server performs service processing on the service request according to the obtained verification information. This reduces the number of failed transaction that occur when the service server interrupts a payment request having a security risk, thereby ensuring transaction security, and improving security verification experience of the user during online payment.

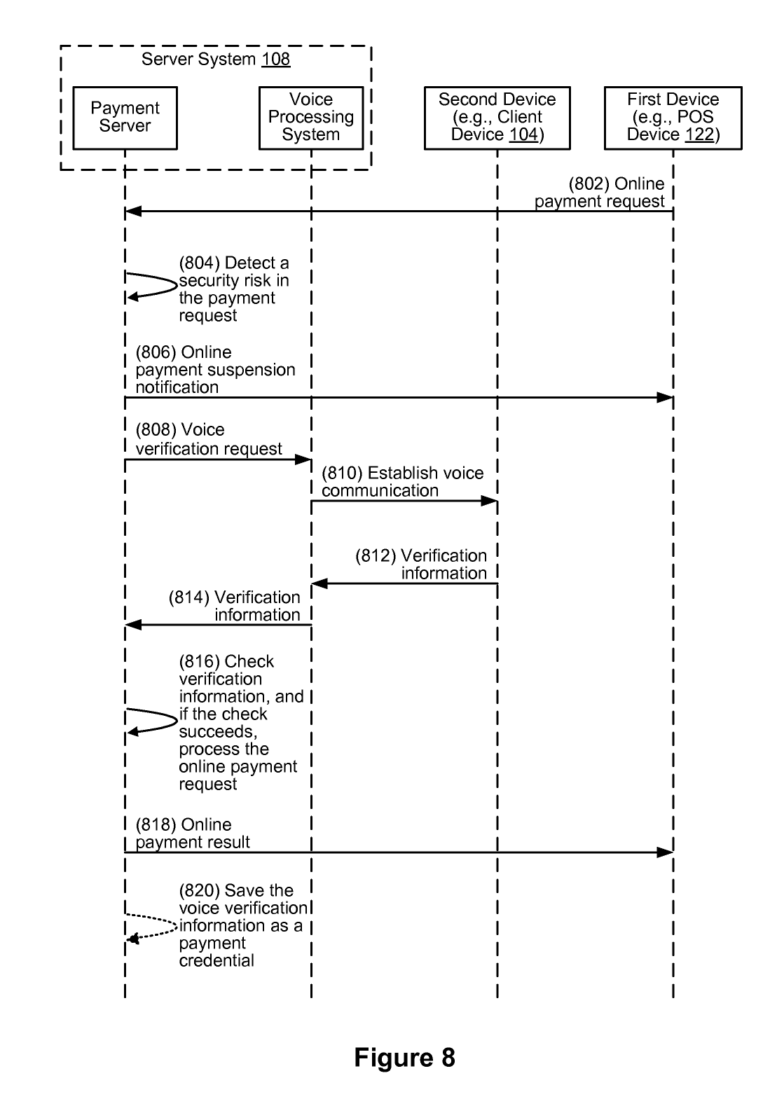

FIG. 8 illustrates a flow diagram of a security verification process in accordance with some embodiments. In some embodiments, the process is performed in server-client environment 100 (FIG. 1) with server system 108 (e.g., including a payment server and a voice processing system), a first device (e.g., POS device 122), and a second device (e.g., client device 104). In this embodiment, the security verification process is described in detail using an online payment process as an example.

A user submits (802) a payment request to a payment server through a first device (e.g., POS device 122). Specifically, the first user terminal in this embodiment is an Internet enabled device such as a personal computer, a tablet computer, a smart phone, or the like, which can submit the payment request to the payment server through a payment/transaction application, an online transaction web page, an instant messaging client, an SNS client, or the like. In some embodiments, the payment request includes payment information such as a transaction identifier or order number and a payment amount.

In some embodiments, the payment server detects (804) a security risk in the payment request. In some embodiments, in accordance with a preset risk assessment mechanism, the payment server performs a risk assessment process on the payment request. For example, the payment server determines whether the payment amount of the payment request exceeds a daily payment preset by the user, whether a previous login of the user to the payment server had a security risk, whether the good or service corresponding to the payment request has a security risk, or the like.

If the payment server determines that the payment request has a security risk, the payment server performs steps 806 and 808. Additionally and/or optional, in some embodiments, the payment server further assigns a security risk level of the payment request according to the preset risk assessment mechanism. For example, the security risks are classified into high, medium, and low risk levels. If the payment request is assigned a high risk level, the payment server rejects the payment request. If the payment request is assigned a low risk level, the payment server performs the payment request and returns a message indicating that the payment processing is successful. If the payment request is assigned a medium risk level, the payment server performs steps 806 and 808.

In some embodiments, the payment server sends (806) a payment processing suspension notification to the first device. As such, the payment server notifies the user that the payment request has a security risk and that the user needs to provide verification information, by means of voice communication with the voice processing system, in order for the payment server to process the payment request.

In some embodiments, the payment server sends (808) a voice verification request to the voice processing system. In some embodiments, the voice verification request includes voice contact information preset by the user. In an optional embodiment, the voice verification request further includes verification content information (e.g., transaction amount, date of birth, security question, and so on), which is used by the voice processing system to prompt the user to provide verification information that corresponds to the verification content information.

In some embodiments, the voice processing system establishes (810) voice communication with a second device (e.g., client device 104). In some embodiments, the voice processing system establishes voice communication with the second device according to the voice contact information included in the voice verification request. For example, the voice processing system dials a fixed-line phone number or mobile phone number preset by the user, and after the user answers the call, the voice communication is established. Further, after establishing voice communication with the second device, according to the verification content information carried in the voice verification request, the voice processing system prompts, manually or by means of automatic voice, the user to provide verification information corresponding to the verification content information via the established voice communication. For example, the voice verification request includes one or more items of verification content information such as “order number,” “payment password,” “payment amount,” “registered contact number,” and the like. Correspondingly, during the voice communication, the voice processing system prompts the user to provide the corresponding verification information according to the verification content information included in the voice verification request. In another example, if the second device includes a voice communication client, the voice processing system initiates a voice communication request by using a voice communication platform number associated with the voice communication client, thereby establishing voice communication with the second device.

In some embodiments, the voice processing system obtains (812), by means of the voice communication, the verification information from the user of the second device. In some embodiments, during voice communication with the voice processing system, the user uses a physical keypad or virtual keys on the user terminal to enter, according to the prompt of the voice processing system, corresponding information related to voice verification request. Thereby the user provides the entered information related as the verification information to the voice processing system by means of the established voice communication. For example, the voice processing system gives the following prompt to the user: “Please enter the order number of this payment, and press the pound key.” Continuing with this example, the user enters the order number of this transaction by pressing keys of the user terminal, and the voice processing system obtains, by means of the voice communication with the user, the order number entered by the user. Subsequently, the voice processing system gives the following prompt to the user: “Please enter the amount of this payment, and press the pound key.” Continuing with this example, the user enters the amount of the transaction by pressing keys of the user terminal, and the voice processing system obtains, by means of the voice communication with the user, the payment amount entered by the user. After obtaining all required verification information, which is default or determined according to the verification content information specified in the voice verification request, the voice processing system notifies the user that the voice verification is completed.

Alternatively, in some embodiments, the user provides the verification information to the voice processing system by means of voice. For example, the user reads the information related to the service request according to the prompt during the voice communication. The voice processing system obtains the voice information which serves as the verification information, and returns the obtained voice information to the service server. Further optionally, the voice processing system prompts the user to read a sentence (e.g., the verification content information, or another piece of information such as “I am XX, and I confirm this payment.”). The voice processing system sends the whole piece of voice information to the service server as a service credential of this service request.

In some embodiments, the voice processing system sends (814) the obtained verification information to the payment server.

In some embodiments, the payment server processes (816) the payment request according to the verification information. In some embodiments, the payment server verifies the verification information by determining whether the verification information matches stored information corresponding to the verification content information. For example, if the voice verification request instructs the voice processing system to prompt the user to provide the order number, the payment server determines whether the order number provided in the verification information is the order number corresponding to the payment request. In another example, if the voice verification request instructs the voice processing system to prompt the user to provide the payment amount, the payment server determines whether the payment amount provided in the verification information is the payment amount corresponding to the current payment request. If the verification succeeds, the payment server performs processes the payment request.

Further, in some embodiments, the payment server adjusts the security risk level assessment of the current payment request according to the verification result. For example, if the verification succeeds, the security risk is downgraded by one level; in other words, it is determined that the current payment request has a lower risk. If the verification fails, the security risk is upgraded by one level; in other words, it is determined that the current payment request has a higher risk.

In some embodiments, the payment server sends (818) an online payment result to the first device.

Optionally, in some embodiments, when the verification information includes voice information, the payment server saves (820) the obtained voice information of the user as a payment credential of the payment request.

When detecting a security risk in a payment request submitted by a user, the payment server performs voice communication with the user via a voice processing system, so as to obtain verification information from the user. Moreover, the payment server processes the payment request according to the obtained verification information. This reduces the number of failed transaction that occur when the payment server interrupts a payment request having a security risk, thereby ensuring transaction security, and improving security verification experience of the user during online payment.

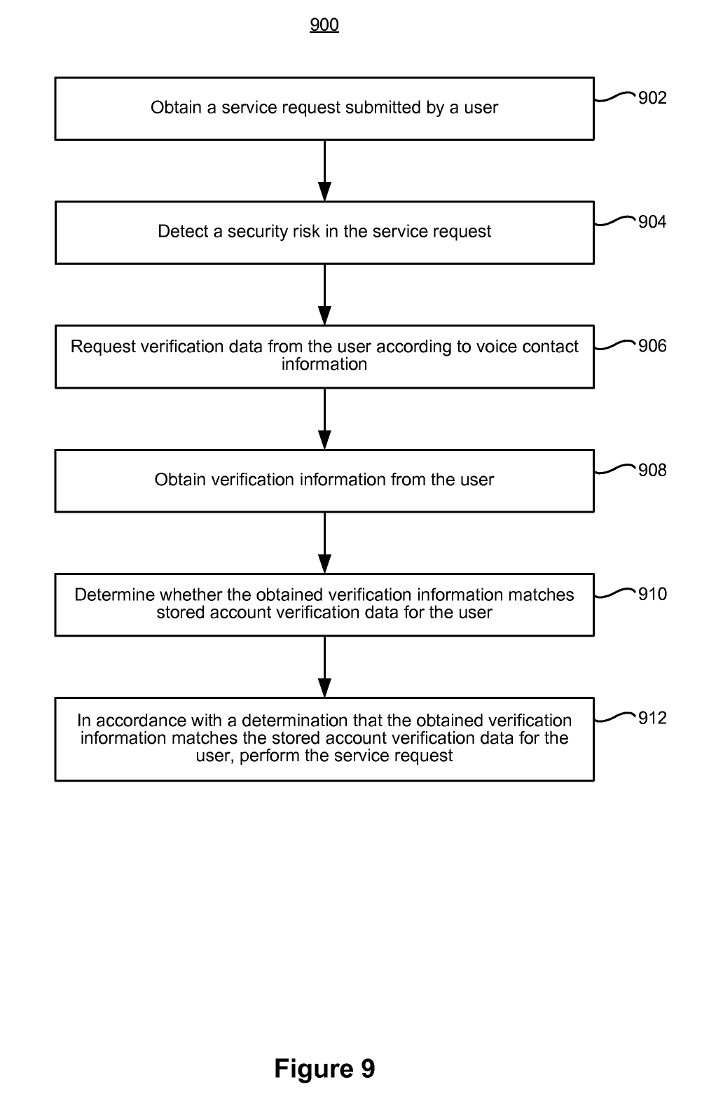

FIG. 9 illustrates a flowchart diagram of a method of verifying a transaction in accordance with some embodiments. In some embodiments, method 900 is performed by a server system with one or more processors and memory. For example, in some embodiments, method 900 is performed by server system 108 (FIGS. 1-2) or a component thereof (e.g., server-side module 106, FIGS. 1-2). In some embodiments, method 900 is governed by instructions that are stored in a non-transitory computer readable storage medium and the instructions are executed by one or more processors of the server system. Optional operations are indicated by dashed lines (e.g., boxes with dashed-line borders).

The server obtains (902) a service request submitted by a user. In some embodiments, the user uses a user terminal such as a mobile phone, a personal computer, and a tablet computer to submit the service request to the service server through a payment/transaction application, a service submission web page, an instant messaging client, an SNS client, or the like. In some embodiments, the service request includes a login request, a transaction request, a payment request, a session request, and the like, where the transaction request and the payment request include payment information such as a transaction order and a payment amount.

The server detects (904) a security risk in the service request. In some embodiments, in accordance with a preset risk assessment mechanism, the service server performs a risk assessment process on the service request. For example, when the service request is a payment request, the server determines whether the payment amount of this service request exceeds a daily payment limit predetermined by the user, whether a previous login of the user to the service server had a security risk, whether the good or service corresponding to the service request has a security risk, or the like.

If the server determines the service request has a security risk, the server performs step 906. Additionally and/or optional, in some embodiments, the service server further assigns a security risk level of the service request according to the preset risk assessment mechanism. For example, the security risks are classified into high, medium, and low risk levels. If the service request is assigned a high risk level, the server rejects the service request. If the service request is assigned a low risk level, the server performs the service request and returns a message indicating that the service processing is successful. If the service request is assigned a medium risk level, the server performs step 906.

Additionally and/or optionally, in some embodiments, after determining that the service request has a security risk, the service server further also provides a notification indicating suspension of service processing to the user. As such, the service server notifies the user that the service request has a security risk and that the user needs to provide verification information, by means of voice communication with the voice processing system, in order for the payment server to process the payment request.

The server requests (906) verification information from the user according to voice contact information preset by the user. Subsequently, the server obtains (908) the verification information from the user.

In some embodiments, the user submits to the service server voice contact information. In turn, the service server saves the voice contact information and associates it with a user identifier, such as a login name, of the user. For example, the voice contact information is a fixed-line phone number, a mobile phone number, a voice communication platform number, an instant messaging number, an SNS account, or the like. After detecting a security risk in step 904, the service server establishes voice communication with the user according to the voice contact information. For example, the service server dials a fixed-line phone number or mobile phone number preset by the user. After the user answers the call, the voice communication is established.

Further, in some embodiments, the service server prompts, manually or by means of automatic voice, the user to provide verification information, by means of the established voice communication, where the verification information is information related to the service request. For example, if the service request is a payment request, the service server prompts the user to enter payment information such as an order number, a payment amount, or a payment password by using a physical keypad or virtual keys on the user terminal to enter, according to the prompt, corresponding payment information. Alternatively, in some embodiments, the user provides the verification information to the service server by means of voice. For example, according to the prompt, the user reads the information related to the service request during the voice communication. After obtaining the voice information from the user, the service server performs voice recognition on the voice information, and uses a recognition result as the voice information of the verification information. Additionally and/or optionally, in some embodiments, after obtaining the voice information from the user, the service server saves the voice information of the user as a service credential of this service request.

Further, in an optional embodiment, if the user submits the service request to the service server through a client that supports voice communication (e.g., an instant messaging client or an SNS client) the service server directly sends the voice communication request to the client, so as to establish voice communication with the user through the client.

Further, in an optional embodiment, a voice processing system (e.g., external from or internal to the server) establishes voice communication with the user and obtains the verification information from the user. Specifically, the optional embodiment includes the following steps:
1) The server sends a voice verification request to the voice processing system through a preset interface (e.g., a TCP/IP interface), where the voice verification request carries the voice contact information (e.g., a mobile phone number) preset by the user in advance. Optionally, the voice verification request further includes verification content information, used by the voice processing system to prompt the user to provide verification information corresponding to the verification content information;
2) The voice processing system performs voice communication with the user according to the voice verification request, and obtains the verification information provided by the user via the voice communication. For example, the voice processing system dials a telephone number preset by the user, and prompts, manually or by means of automatic voice, the user to provide the verification information. For example, the voice processing system plays a preset voice prompt such as “Please enter the order number of this payment, and press the pound key.” Additionally and/or optionally, in some embodiments, the voice processing system chooses one of a plurality of voice prompts to play based on the verification content information included in the voice verification request. Further, in an optional embodiment, if the user submits the service request to the service server through a client that supports voice communication (e.g., an instant messaging client or an SNS client) the voice processing system directly sends the voice communication request to the client, so as to establish voice communication with the user through the client; and
3) The voice processing system sends the obtained verification information to the server.

The server determines (910) whether the obtained verification information matches stored account verification data for the user. In some embodiments, the service server verifies the obtained verification information by determining whether the verification information is the same as the related information corresponding to the service request (e.g., by comparison). For example, if the service request is a payment request, the service server determines whether the order number included in the verification information is the order number corresponding to the current service request, whether the payment amount included in the verification information is the payment amount corresponding to the current service request, whether the payment password included in the verification information is the payment password preset by the user, whether the password included in the verification information is the payment password preset by the user, or the like. If the verification succeeds, the service server performs subsequent service processing of the service request.

In accordance with a determination that the obtained verification information matches the stored account verification data, the server performs (912) the service request. Further, in some embodiments, the service server adjusts the security risk level assessment of the current service request according to the verification result. For example, if the verification succeeds, the security risk is downgraded by one level; in other words, it is determined that the current service request has a lower risk. If the verification fails, the security risk is upgraded by one level; in other words, it is determined that the current service request has a higher risk.

When detecting a security risk in a service request submitted by a user, the server obtains verification information from the user. Moreover, the service server performs service processing on the service request according to the obtained verification information. This reduces the number of failed transaction that occur when the service server interrupts a payment request having a security risk, thereby ensuring transaction security, and improving security verification experience of the user during online payment.

FIGS. 10A-10C illustrate a flowchart diagram of a method of real-time voice verification of a transaction in accordance with some embodiments. In some embodiments, method 1000 is performed by a server system with one or more processors and memory. For example, in some embodiments, method 1000 is performed by server system 108 (FIGS. 1-2) or a component thereof (e.g., server-side module 106, FIGS. 1-2). In some embodiments, method 1000 is governed by instructions that are stored in a non-transitory computer readable storage medium and the instructions are executed by one or more processors of the server system. Optional operations are indicated by dashed lines (e.g., boxes with dashed-line borders).

The server system receives (1002) a transaction request from a first device to perform a transaction with an account. In some embodiments, server system 108 or a component thereof (e.g., transaction handling module 222, FIG. 2) receives the transaction request from the first device and performs a security verification process to verify the transaction. For example, the first device is a merchant's point-of-sale (“POS”) device, a device associated with the user that lacks voice capture and/or communication capabilities, or a device associated with a sub-user of a purchase account that is managed by an administrator or a super user of the account. In some embodiments, the transaction is associated with a purchase of goods and/or services initiated at the first device with the account, and the transaction request includes a transaction identifier or order number and a purchase amount for the transaction. For example, the account corresponds to a credit card or payment account used for the transaction.

In response to receiving the transaction request, the server system determines (1004) a security level for the transaction based on one or more parameters of the transaction and/or the account. In some embodiments, server system 108 or a component thereof (e.g., security determination module 224, FIG. 2) determines a security level or security risk associated with the transaction based on one or more factors corresponding to the transaction and the account used to initiate the transaction. For example, the factors used in determining the security level include the amount of the transaction, type of good or service associated with the transaction, location of the transaction, user/sub-account initiating the transaction, a daily purchase limit associated with the account, and so on. In some embodiments, security determination module 224 assigns a security level to the transaction request: high, medium, or low.

In accordance with a determination that the security level for the transaction meets (1006) a predetermined criterion, the server system: instructs (1008) the first device to suspend the transaction and to display a first interface on the first device indicating suspension of the transaction and sends (1010) a confirmation request to a second device associated with the account to request voice verification for the transaction. In some embodiments, the transaction meets the predetermined criterion when the security risk assigned to the transaction by security determination module 224 is a high or medium level risk. FIG. 5B, for example, shows notification 520 displayed on the first device (e.g., POS device 122, FIGS. 1 and 3), which indicates that the transaction has been suspended pending voice verification. FIG. 6A, for example, shows notification 610 (e.g., associated with the confirmation request) displayed on the second device (e.g., client device 104, FIGS. 1 and 4), which prompts the user of client device 104 to enter voice verification information for the transaction.

In some embodiments, the confirmation request includes (1012) a prompt for voice input containing specified information regarding the transaction. In some embodiments, the confirmation request prompts the user of client device 104 to provide a voice input indentifying specific information related to the transaction such as the transaction location, transaction identifier, order number, or purchase amount. In one example, if a thief is attempting to use a credit card at a merchant's POS device, the transaction must be verified by a voice input associated with details of the transaction (e.g., transaction location or transaction amount) received from another device associated with the true credit card holder (e.g., the true credit card account holder's mobile phone). As such, because the credit card is being used by the thief in this example, the true credit card holder cannot provide the details of the transaction to verify the transaction (e.g., because the true credit card holder did not initiate the transaction and the true credit card holder is not present at the location where the transaction was initiated) and the transaction will not be processed.

In some embodiments, the confirmation request includes (1014) a prompt for voice input containing specified account information for the account. In some embodiments, the confirmation request prompts the user of client device 104 to provide a voice input indentifying specific information related to account used to initiate the transaction such as date of birth, social security number, billing address, security question, and the like.

In response to the confirmation request, the server system receives (1016) voice verification information from the second device, where the voice verification information includes audio data provided by a user of the second device.

In some embodiments, the first device also corresponds to (1018) the user. In some embodiments, the first device has limited capabilities (e.g., no voice capture and/or only WiFi capabilities—no GSM/CDMA or other telecommunications capabilities) compared to the second device with voice capture and telecommunication capabilities. In another embodiment, the first and second devices are associated with different users. For example, the first device is associated with a child who has limited purchase authority and the second device is associated with the child's parent who has administrative/super-user authority over the account and, therefore, over the child's purchases.

In some embodiments, the first device is associated with (1020) a merchant. For example, the first device is a POS terminal with a magnetic card reader that is installed at a cashier's station of a merchant/retail store or a mobile POS device.

The server system determines (1022) whether the voice verification information matches stored account verification data corresponding to the account. In some embodiments, server system 108 stores one or more user profiles 116 for a plurality of users with accounts. A respective profile for a respective user includes account verification data 252 corresponding to the account of the respective user such as the social security number, date of birth, security question and answer, biometric voice signature, and/or the like for the respective user. In some embodiments, server system 108 or a component thereof (e.g., verification module 232, FIG. 2) determines whether the voice verification information matches stored account verification data associated with the account that was used to initiate the transaction at the first device.

In some embodiments, determining whether the voice verification information matches stored account verification data corresponding to the account further comprises (1024) determining whether the voice verification information includes the specified information regarding the transaction or the specified account information for the account. In some embodiments, server system 108 or a component thereof (e.g., verification module 232, FIG. 2) determines whether the voice verification information includes the specified information regarding the transaction (e.g., the transaction identifier or transaction amount) or the specified account information for the account (e.g., date of birth or security question(s)).

In some embodiments, determining whether the voice verification information matches stored account verification data corresponding to the account further comprises (1026): extracting a voice signature from the voice verification information; and determining whether the extracted voice signature matches a stored voice signature corresponding to the account. In some embodiments, server system 108 or a component thereof (e.g., voice signature module 234, FIG. 2) extracts a voice signature from the voice verification information. For example, the voice signature is an audio fingerprint with a plurality of vocal features of the user. In some embodiments, after voice signature module 234 extracts the voice signature from the voice verification information, verification module 232 determines whether the extracted voice signature against matches a stored voice signature corresponding to the account that initiated the transaction at the first device (e.g., included as part of account verification data 252 in the user profile for the account).

In accordance with at least a determination that the voice verification information matches (1028) the stored account verification data corresponding to the account, the server system: processes (1030) the transaction; and instructs (1032) the first device to complete the transaction and to replace display of the first interface on the first device with a second interface indicating completion of the transaction. In some embodiments, in addition to handling security verification, the server is a payment server that also processes the transaction or causes the transaction to be processed by another server (e.g., a server associated with a credit card company). FIG. 5C, for example, shows notification 530 displayed on the first device (e.g., POS device 122, FIGS. 1 and 3), which indicates that the transaction has been processed.

In some embodiments, receiving the transaction request from the first device, instructing the first device to suspend the transaction, and instructing the first device to complete the transaction occur (1034) at the server system during a single transaction session executed at the first device. In some embodiments, verification of the transaction occurs in real-time during a same transaction session at the first device. For example, the initiator of the transaction cannot go home and then complete the transaction. In some embodiments, verification of the transaction occurs within a predetermined time window.

In some embodiments, in accordance with the determination that the voice verification information matches (1028) the stored account verification data corresponding to the account, the server system (1036): extracts a voice signature from the voice verification information; and associates the extracted voice signature with the account. In some embodiments, when the user profile corresponding to the account does not include a voice signature, server system 108 or a component thereof (e.g., voice signature module 234, FIG. 2) extracts a voice signature from the voice verification information and saves the extracted voice signature in the user profile associated with the account. For example, the extracted voice signature is saved as an additional credential of the account verification data 252 associated with the account for subsequent verification.

In some embodiments, in accordance with the determination that the security level corresponding to the transaction request meets (1006) the predetermined criterion, the server system (1038) determines whether the first device and the second device are located within a predetermined distance, where processing the transaction and instructing the first device are performed in accordance with both the determination that the voice verification information matches the stored account verification data corresponding to the account and a determination that the first device and the second device are located within the predetermined distance. In some embodiments, server system 108 or a component thereof (e.g., proximity module 238, FIG. 2) determines a distance between the first device and the second device based on location information obtained from the first device and the second device. For example, the predetermined distance requires that first and second devices be within arm's reach (i.e., the devices cannot be more than X meters apart).

Optionally, in some embodiments, verification of the voice verification information AND proximity is only required when security determination module 224 assigns a high security risk to the transaction. Optionally, in some embodiments, a transaction with a high security risk requires verification of the voice verification information AND proximity AND voice signature.

In some embodiments, the server system (1040) extracts a portion of the voice verification information in accordance with predetermined privacy criterion associated with the account, and the server system sends the extracted portion of the voice verification information to the first device. In some embodiments, after determining that the voice verification information matches the stored account verification data corresponding to the account, server system 108 sends a portion of the voice verification information to the first device (e.g., POS device 122, FIGS. 1 and 3) in accordance with predetermined privacy criterion of the account. In some embodiments, the predetermined privacy criterion is stored as a portion of account preferences 254 of a user profile for the account that is stored in one or more user profiles 116. For example, the user does not trust the first device/merchant with his/her biometric information and the predetermined privacy criterion indicates that server system 108 is only able to send non-sensitive, non-biometric information to the first device/merchant such as an email address for sending the receipt and/or shipping address.

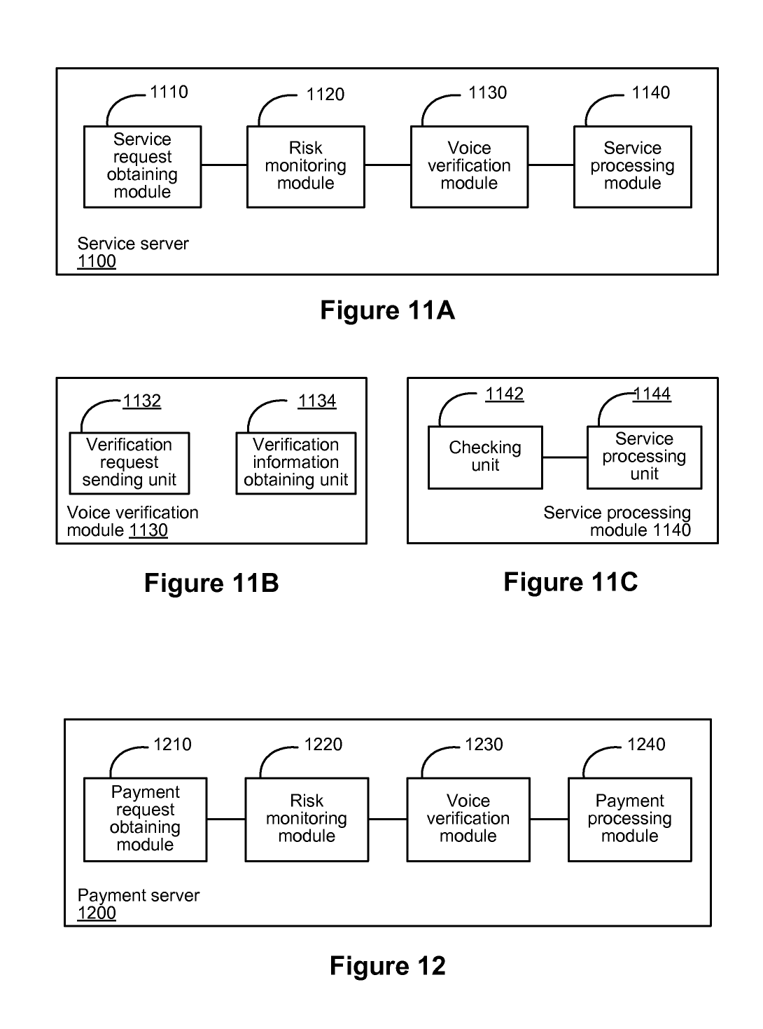

FIGS. 11A illustrates a block diagram of a service server 1100 in accordance with some embodiments. In accordance with some embodiments, the security verification process described in FIG. 7 includes service server 1100. For example, the service server is an application server, an instant messaging server, an SNS server, a payment server, a security verification server, or the like. In some embodiments, service server 1100 includes the following modules: service request obtaining module 1110; risk monitoring module 1120; voice verification module 1130; and service processing module 1140.

In some embodiments, service request obtaining module 1110 is configured to obtain a service request submitted by a user of a device. For example, the user uses a user terminal, such as a mobile phone, a personal computer, and a tablet computer, to submit the service request to the service server 1100 through a payment/transaction application, an online transaction web page, an instant messaging client, an SNS client, or the like. For example, the service request includes a login request, a transaction request, a payment request, a session request, and the like. In some embodiments, the service request includes payment information such as a transaction identifier or order number and a payment amount.

In some embodiments, risk monitoring module 1120 is configured to determine whether the service request has a security risk. In some embodiments, in accordance with a preset risk assessment mechanism, risk monitoring module 1120 performs a risk assessment process on the service request. For example, the service server determines whether the payment amount of this service request exceeds a daily payment limit predetermined by the user, whether a previous login of the user to the service server had a security risk, whether the good or service corresponding to the service request has a security risk, or the like.

In some embodiments, when risk monitoring module 1120 detects a security risk in the service request, voice verification module 1130 is configured to establish voice communication with device associated with the user according to preset voice contact information and obtain verification information provided by the user. The voice contact information is, for example, a fixed-line phone number, a mobile phone number, a voice communication platform number, an instant messaging number, an SNS account, or the like. For example, the verification information provided by the user includes any one or any combination of a transaction order number, a payment amount, a payment password, and a registered mobile phone number.

In some embodiments, service processing module 1140 is configured to perform service processing of the service request according to the verification information. In some embodiments, service processing module 1140 verifies the obtained verification information by determining whether the verification information is the same as the related information corresponding to the service request (e.g., by comparison). If the verification succeeds, service processing module 1140 performs service processing on the service request.

FIGS. 11B-11C illustrate block diagrams of modules associated with service server 1100 in FIG. 11A in accordance with some embodiments.

In FIG. 11B, voice verification module 1130 includes verification request sending unit 1132 and verification information obtaining unit 1134.

In some embodiments, verification request sending unit 1132 is configured to send, to a voice processing system, a voice verification request that includes voice contact information preset by the user.

In turn, the voice processing system establishes voice communication with the user according to the voice contact information. For example, according to the voice contact information included in the voice verification request sent by verification request sending unit 1132, the voice processing system dials a fixed-line phone number or a mobile phone number, and after the user answers the call, the voice communication is established. Further, the voice processing system prompts, manually or by means of automatic voice, the user to provide the verification information by means of the established voice communication. Further, in an optional embodiment, if the user submits the service request to the service server through a client that supports voice communication, for example, an instant messaging client or an SNS client, the voice processing system directly sends a voice communication request to the client that supports voice communication, so as to establish voice communication with the user through the client. In an optional embodiment, the voice verification request further includes verification content information. As such, according to verification content information, the voice processing system prompts the user to provide verification information corresponding to the verification content information. After obtaining all required verification information, which is default or determined according to the verification content information specified in the voice verification request, the voice processing system notifies the user that the voice verification is completed.

In some embodiments, verification information obtaining unit 1134 is configured to obtain from the voice processing system the verification information provided by the user.

In FIG. 11C, service processing module 1140 includes checking unit 1142 and service processing unit 1144.

In some embodiments, checking unit 1142 is configured to determine whether the verification information provided by the user matches the information related to the service request and the verification content information. For example, if the voice verification request instructs the voice processing system to prompt the user to provide the order number, checking unit 1142 determines whether the order number provided in the verification information is the order number corresponding to the payment request. In another example, if the voice verification request instructs the voice processing system to prompt the user to provide the payment amount, checking unit 1142 determines whether the payment amount provided in the verification information is the payment amount corresponding to the current payment request.

In some embodiments, in accordance with a determination that the verification by checking unit 1142 succeeds, service processing unit 1144 is configured to perform service processing on the service request.

FIG. 12 illustrates a block diagram of a payment server 1200 in accordance with some embodiments. In accordance with some embodiments, the security verification process described in FIG. 8 includes payment server 1200. For example, the service payment is an application server, an instant messaging server, an SNS server, a payment server, a security verification server, or the like. In some embodiments, payment server 1200 includes the following modules: payment request obtaining module 1210; risk monitoring module 1220; voice verification module 1230; and payment processing module 1240.

In some embodiments, payment request obtaining module 1210 is configured to obtain a payment request submitted by a user at a first device.

In some embodiments, risk monitoring module 1220 is configured to determine whether the payment request has a security risk.

In some embodiments, when risk monitoring module 1220 detects a security risk in the payment request, voice verification module 1230 is configured to: establish voice communication with a second device user according to voice contact information preset by the user; and obtain, by means of the voice communication, verification information provided by a user of the second device. In some embodiments, voice verification module 1230 is also configured to determine whether the obtained verification information matches stored account verification data corresponding to the user of the second device.

In some embodiments, when voice verification module 1230 verifies the verification information, payment processing module 1240 is configured to process the payment request.

While particular embodiments are described above, it will be understood it is not intended to limit the application to these particular embodiments. On the contrary, the application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of real-time voice verification of a transaction, comprising:
at a server system with one or more processors and memory:
receiving a transaction request from a first device to perform a transaction with an account;
in response to receiving the transaction request, determining a security level for the transaction based on one or more parameters of the transaction or the account; and
in accordance with a determination that the security level for the transaction meets a predetermined criterion:
instructing the first device to suspend the transaction and to display a first interface on the first device indicating suspension of the transaction;
sending a confirmation request to a second device associated with the account to request voice verification for the transaction;
in response to the confirmation request, receiving voice verification information from the second device, wherein the voice verification information includes audio data provided by a user of the second device; and
in accordance with at least a determination that the voice verification information matches the stored account verification data corresponding to the account:
processing the transaction; and
instructing the first device to complete the transaction and to replace display of the first interface on the first device with a second interface indicating completion of the transaction.

2. The method of claim 1, wherein receiving the transaction request from the first device, instructing the first device to suspend the transaction, and instructing the first device to complete the transaction occur at the server system during a single transaction session executed at the first device.

3. The method of claim 1, wherein the confirmation request includes a prompt for voice input containing specified information regarding the transaction.

4. The method of claim 1, wherein the confirmation request includes a prompt for voice input containing specified account information for the account.

5. The method of claim 1, wherein determining whether the voice verification information matches stored account verification data corresponding to the account further comprises:
extracting a voice signature from the voice verification information; and
determining whether the extracted voice signature matches a stored voice signature corresponding to the account.

6. The method of claim 1, further comprising:
in accordance with the determination that the voice verification information matches the stored account verification data corresponding to the account:
extracting a voice signature from the voice verification information; and
associating the extracted voice signature with the account.

7. The method of claim 1, further comprising:
in accordance with the determination that the security level corresponding to the transaction request meets the predetermined criterion:
determining whether the first device and the second device are located within a predetermined distance, and
wherein processing the transaction and instructing the first device are performed in accordance with both the determination that the voice verification information matches the stored account verification data corresponding to the account and a determination that the first device and the second device are located within the predetermined distance.

8. The method of claim 1, further comprising:
extracting a portion of the voice verification information in accordance with predetermined privacy criterion associated with the account; and
sending the extracted portion of the voice verification information to the first device.

9. A server system, comprising:
one or more processors; and
memory storing one or more programs to be executed by the one or more processors, the one or more programs comprising instructions for:
receiving a transaction request from a first device to perform a transaction with an account;
in response to receiving the transaction request, determining a security level for the transaction based on one or more parameters of the transaction or the account; and
in accordance with a determination that the security level for the transaction meets a predetermined criterion:
instructing the first device to suspend the transaction and to display a first interface on the first device indicating suspension of the transaction;
sending a confirmation request to a second device associated with the account to request voice verification for the transaction;
in response to the confirmation request, receiving voice verification information from the second device, wherein the voice verification information includes audio data provided by a user of the second device; and
in accordance with at least a determination that the voice verification information matches the stored account verification data corresponding to the account:
processing the transaction; and
instructing the first device to complete the transaction and to replace display of the first interface on the first device with a second interface indicating completion of the transaction.

10. The server system of claim 9, wherein receiving the transaction request from the first device, instructing the first device to suspend the transaction, and instructing the first device to complete the transaction occur at the server system during a single transaction session executed at the first device.

11. The server system of claim 9, wherein the confirmation request includes a prompt for voice input containing specified information regarding the transaction.

12. The server system of claim 9, wherein the confirmation request includes a prompt for voice input containing specified account information for the account.

13. The server system of claim 9, wherein determining whether the voice verification information matches stored account verification data corresponding to the account further comprises:
extracting a voice signature from the voice verification information; and
determining whether the extracted voice signature matches a stored voice signature corresponding to the account.

14. The server system of claim 9, wherein the one or more programs further comprise instructions for:
extracting a portion of the voice verification information in accordance with predetermined privacy criterion associated with the account; and
sending the extracted portion of the voice verification information to the first device.

15. A non-transitory computer readable storage medium storing one or more programs, the one or more programs comprising instructions, which, when executed by a server system with one or more processors, cause the server system to perform operations comprising:
receiving a transaction request from a first device to perform a transaction with an account;
in response to receiving the transaction request, determining a security level for the transaction based on one or more parameters of the transaction or the account; and
in accordance with a determination that the security level for the transaction meets a predetermined criterion:
instructing the first device to suspend the transaction and to display a first interface on the first device indicating suspension of the transaction;
sending a confirmation request to a second device associated with the account to request voice verification for the transaction;
in response to the confirmation request, receiving voice verification information from the second device, wherein the voice verification information includes audio data provided by a user of the second device; and
in accordance with at least a determination that the voice verification information matches the stored account verification data corresponding to the account:
processing the transaction; and
instructing the first device to complete the transaction and to replace display of the first interface

16. The non-transitory computer readable storage medium of claim 15, wherein receiving the transaction request from the first device, instructing the first device to suspend the transaction, and instructing the first device to complete the transaction occur at the server system during a single transaction session executed at the first device.

17. The non-transitory computer readable storage medium of claim 15, wherein the confirmation request includes a prompt for voice input containing specified information regarding the transaction.

18. The non-transitory computer readable storage medium of claim 15, wherein the confirmation request includes a prompt for voice input containing specified account information for the account.

19. The non-transitory computer readable storage medium of claim 15, wherein determining whether the voice verification information matches stored account verification data corresponding to the account further comprises:
extracting a voice signature from the voice verification information; and
determining whether the extracted voice signature matches a stored voice signature corresponding to the account.

20. The non-transitory computer readable storage medium of claim 15, wherein the one or more programs further comprise instructions, which cause the server system to perform operations comprising:
extracting a portion of the voice verification information in accordance with predetermined privacy criterion associated with the account; and
sending the extracted portion of the voice verification information to the first device.
